(19) United States
(12) Patent Application Publication
(10) Pub. No.: US 2014/0293312 A1
(43) Pub. Date: Oct. 2, 2014

(54) INFORMATION PROCESSING APPARATUS, PRINT CONTROL PROGRAM AND PRINT SYSTEM

(71) Applicant: Naoki FUKASAWA, Kanagawa (JP)

(72) Inventor: Naoki FUKASAWA, Kanagawa (JP)

(73) Assignee: RICOH COMPANY, LTD., Tokyo (JP)

(21) Appl. No.: 14/225,753

(22) Filed: Mar. 26, 2014

(30) Foreign Application Priority Data
Mar. 27, 2013 (JP) 2013-066053
Feb. 21, 2014 (JP) 2014-032143

(51) Int. Cl. G06K 15/00; G06K 15/02; G06F 3/048

(52) U.S. Cl. CPC G06K 15/005; G06F 3/048; G06K 15/1806
USPC 358/1.13; 358/1.15

(57) ABSTRACT

An information processing apparatus includes a first generation unit that generates process information related to a process required of an image processing apparatus based on function description information indicating plural setting items related to a function of the image processing apparatus and a first prohibition at the plural setting items, and additional function information indicating information for requiring of the image processing apparatus a function different from a function of the plural setting items; a second generation unit that generates extended print setting information based on extended function description information indicating a second prohibition different from the first prohibition and the process information, the extended print setting information being for performing a display reflecting the second prohibition; and a display control unit that displays an image for receiving a setting related to a print process required of the image processing apparatus, based on the extended print setting information.

### BACKGROUND OF THE INVENTION

1. Field of the Invention

The disclosures herein generally relate to an information processing apparatus, a print control program and a print system.

2. Description of the Related Art

A user can set various setting items for print functions in an image forming apparatus by using a user interface (UI) provided by a printer driver installed in a computer such as a personal computer (PC) which uses the image forming apparatus such as a printer.

The related art disclosures prevent the user from setting contents that contradict each other when the user changes the setting items, by imposing a prohibition (prevention) on a combination of the respective setting items in the printer driver.

For example, Japanese Published Patent Application No. 2011-22679 discloses a printer driver, which prevents the user, who changes content of a print setting item, from making an unintended change of a content of other print setting items, and thereby enhancing operability of changing the print setting item for the user. In Japanese Published Patent Application No. 2011-22679, in the case that a print setting content of function “A” is changed, and a function “B” exists, where the function “B” is prohibited by the function “A”, when a priority of the function “A” is higher than that of the function “B”, the printer driver maintains the print setting content of the function “A”, and thereby preserves the prohibition condition. The print setting content of the function “B” is changed so as not to prohibit the changed print setting content. The prohibition process ends when the change of the print setting content of the function “B” is determined to be successful.

However, the printer driver disclosed in Japanese Published Patent Application No. 2011-22679 merely describes prohibition of a combination between predetermined setting items, but does not describe prohibition of combinations between other setting items. In order to describe the prohibition for the other print setting items, the printer driver requires development of a module to solve the problem of prohibition of the other print setting items.

Moreover, the printer driver disclosed in Japanese Published Patent Application No. 2011-22679 can cooperate with a Device Companion Application (DCA) according only to the mode defined in the OS (operation system). Accordingly, for example, when the above module is controlled by the printer driver, the DCA cannot utilize an application of the module.

### SUMMARY OF THE INVENTION

It is a general object of at least one embodiment of the present invention to provide an information processing apparatus, a print control program and a print system that substantially obviate one or more problems caused by the limitations and disadvantages of the related art.

In one embodiment, an information processing apparatus includes a first generation unit that generates process information, based on function description information indicating plural setting items related to a function of an image processing apparatus and a prohibition at the plural setting items, and additional function information indicating information for requiring of the image processing apparatus a function different from a function of the plural setting items indicated by the function description information, the process information being related to a process required of the image processing apparatus; a second generation unit that generates extended print setting information, based on extended function description information indicating a prohibition different from the prohibition indicated by the function description information, and the process information generated by the first generation unit, the extended print setting information being for performing a display reflecting the prohibition indicated by the extended function description information; and a display control unit that displays an image for receiving a setting related to a print process required of the image processing apparatus, based on the extended print setting information generated by the second generation unit.

In another embodiment, a non-transitory computer-readable storage medium stores a program for causing a computer to perform a process of controlling printing. The process includes a first generation step of generating process information, based on function description information indicating plural setting items related to a function of an image processing apparatus and a prohibition at the plural setting items, and additional function information indicating information for requiring of the image processing apparatus a function different from a function of the plural setting items indicated by the function description information, the process information being related to a process required of the image processing apparatus; a second generation step of generating extended print setting information, based on extended function description information indicating a prohibition different from the prohibition indicated by the function description information, and the process information generated in the first generation step, the extended print setting information being for performing a display reflecting the prohibition indicated by the extended function description information; and a display control step of displaying an image for receiving a setting related to a print process required of the image processing apparatus, based on the extended print setting information generated in the second generation step.

In yet another embodiment, a print system includes an information processing apparatus and an image processing apparatus, which are connected to each other via a network. The image processing apparatus includes a first generation unit that generates process information, based on function description information indicating plural setting items related to a function of the image processing apparatus and a prohibition at the plural setting items, and additional function information indicating information for requiring of the image processing apparatus a function different from a function of the plural setting items indicated by the function description information, the process information being related to a process required of the image processing apparatus; a second generation unit that generates extended print setting information, based on extended function description information indicating a prohibition different from the prohibition indicated by the function description information, and the process information generated by the first generation unit, the extended print setting information being for performing a display reflecting the prohibition indicated by the extended function description information; and a display control unit that displays an image for receiving a setting related to a print process required of the image processing apparatus, based on the extended print setting information generated by the second generation unit. The image processing apparatus processes print target data based on the extended print setting information.

According to the embodiment, an extended function description, which is not included in the predetermined function descriptions, can be set as a print setting item.

### BRIEF DESCRIPTION OF THE DRAWINGS

Other objects and further features of embodiments will be apparent from the following detailed description when read in conjunction with the accompanying drawings, in which:

FIG. 1 is a diagram illustrating a configuration of a general-purpose printer driver;

FIG. 2 is a diagram illustrating a configuration of a package of the printer driver;

FIG. 3 is an explanatory diagram illustrating an example of acquisition of a print function setting item using a general-purpose OS;

FIG. 4 is a diagram illustrating an example of a whole configuration of a print system according to a present embodiment;

FIG. 5 is a diagram illustrating an example of a function configuration of a printer driver and a UI display unit according to the present embodiment;

FIG. 6 is a diagram illustrating an example of a function description according to the present embodiment;

FIG. 7 is a diagram illustrating an example of an extended storage setting according to the present embodiment;

FIG. 8 is a diagram illustrating an example of a conversion script according to the present embodiment;

FIG. 9 is a diagram illustrating an example of a device setting screen according to the present embodiment;

FIG. 10 is a diagram illustrating an example of a print capability according to the present embodiment;

FIG. 11 is a diagram illustrating an example of a print ticket according to the present embodiment;

FIG. 12 is a diagram illustrating an example of a print capability where the setting value is changed according to the present embodiment;

FIG. 13 is a diagram illustrating an example of a print ticket where the setting value is changed according to the present embodiment;

FIG. 14 is a diagram illustrating an example of an extended function description according to the present embodiment;

FIG. 15 is a sequence diagram illustrating an example of a process of starting a GUI and a process of changing a setting value by a user according to the present embodiment;

FIG. 16 is a flowchart illustrating an example of a process of initializing by a function management unit according to the present embodiment;

FIG. 17 is a flowchart illustrating an example of a setting process of a setting value by the function management unit according to the present embodiment;

FIG. 18 is a diagram illustrating an example of extended print setting information according to the present embodiment;

FIG. 19 is a diagram illustrating an example of a GUI layout setting file according to the present embodiment;

FIG. 20 is a flowchart illustrating an example of a process of updating a display of the GUI screen according to the present embodiment;

FIGS. 21A and 21B are diagrams illustrating examples of displays of the GUI screen according to the present embodiment;

FIG. 22 is a diagram illustrating an example of a display of a message of a reason of prohibition according to the present embodiment;

FIG. 23 is a diagram illustrating a first other example of the extended print setting information according to the present embodiment;

FIGS. 24A and 24B are diagrams illustrating a first example of updated displays of the GUI screen according to the present embodiment;

FIG. 25 is a diagram illustrating an example of the display of message of the reason of prohibition according to the present embodiment;

FIG. 26 is a diagram illustrating a second other example of the extended print setting information according to the present embodiment;

FIGS. 27A and 27B are diagrams illustrating a second example of updated displays of the GUI screen according to the present embodiment;

FIG. 28 is a diagram illustrating an example of a configuration of a print system according to variation of the present embodiment; and

FIG. 29 is a diagram illustrating an example of a hardware configuration of a control unit according to the present embodiment.

### DESCRIPTION OF THE PREFERRED EMBODIMENTS

In the following, embodiments of the present invention will be described with reference to the accompanying drawings. In the specification and the drawings, to substantially the same or corresponding members or parts, the same reference sign is given and redundant explanation will be omitted.

<Preparation>

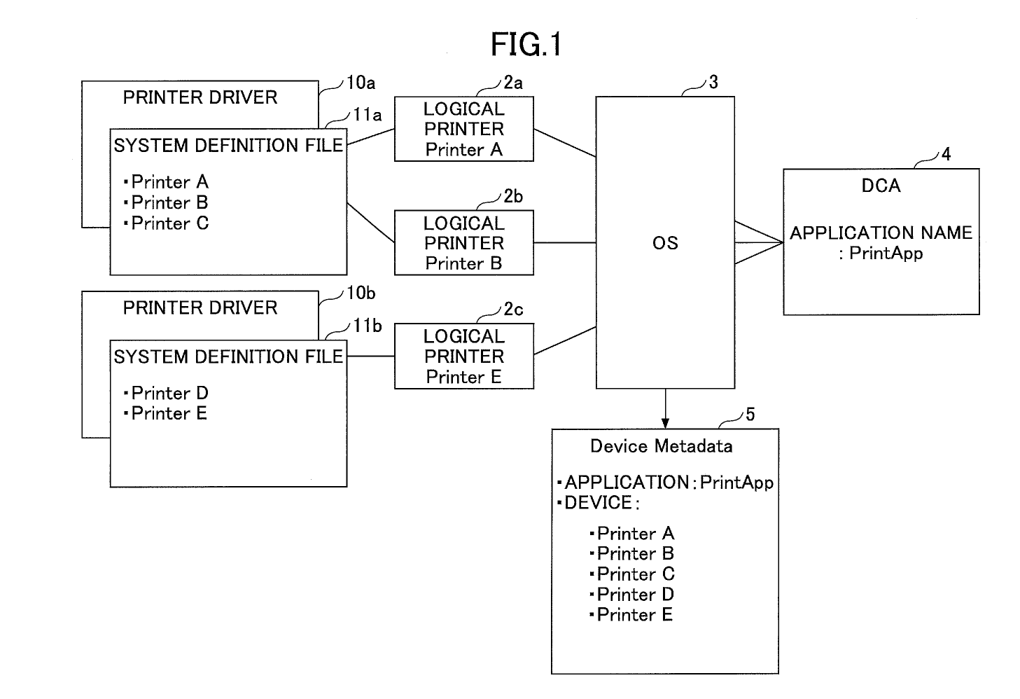

Before describing the embodiment of the present invention, a general-purpose printer driver will be explained with reference to FIGS. 1 to 3. At first, referring to FIG. 1, an example of a configuration of a general-purpose printer driver will be described.

Printer drivers 10a and 10b are, for example, installed in a memory in a personal computer (PC). The printer drivers 10a and 10b control print operations for a printer connected via a network.

In a system definition file, having an extension “inf”, of the printer drivers 10a and 10b, a list of plug-and-play IDs (PnP ID) of printer devices, which the respective printer drivers 10a and 10b, which will be also denoted “printer driver 10” in the following, deal with, is described. As shown in FIG. 1, in the system definition file 11a, “Printers A, B, C” are defined as the PnP IDs. In the system definition file 11b, “Printers D, E” are defined as the PnP IDs.

When a printer device having a plug-and-play ID (PnP ID) is connected to the PC or the like, the operating system (OS) 3 of Windows (trademark registered) or the like generates a logical printer connected to a printer driver corresponding to the printer device. In FIG. 1, connected to the printer driver 10a, a logical printer (Printer A) 2a and a logical printer (Printer B) 2b are generated. Moreover, connected to the printer driver 10b, a logical printer (Printer E) 2c is generated.

In a driver, which will be called Version 4 for simplicity in the following, there are modules of a DCA (Device Companion Application) 4 and a device metadata 5.

The DCA 4 is a kind of a Windows store application, and an application in order to extend an experience of the device. In the DCA 4 of a printer, a printer setting screen unique to the printer vender can be displayed. Moreover, the DCA 4 has a unique name “Print App” so as to uniquely discriminate the application.

The device metadata 5 is a file which holds meta information such as a kind of the device or an explanation. The device meta data 5 includes a unique name “Print App” of the application and a list of the PnP IDs of the devices “Printers A, B, C, D, E”, and the devices and the DCA 4 are connected.

The DCA 4 is uploaded by a vendor in the Windows store, and is distributed from there. The device metadata 5 is uploaded by a vendor on a server managed by Windows OS 3 and is called a device metadata store, and the DCA 4 is distributed from the device metadata store.

When a device is installed in the following flow, the device metadata 5 and the DCA 4 are automatically installed in Windows, and the logical printer and the DCA 4 are connected to each other.

1. When connected to the device, a logical printer is installed according to the PnP;

2. Windows searches for a device metadata 5 having the PnP ID in the device metadata store;

3. When the device metadata 5 is found, the device metadata 5 is downloaded and installed in Windows;

4. Windows searches for an application which the unique name set in the device metadata 5 identifies in the Windows store;

5. When the application is found, the application is installed in Windows; and

6. The DCA 4 and the logical printer are connected in Windows.

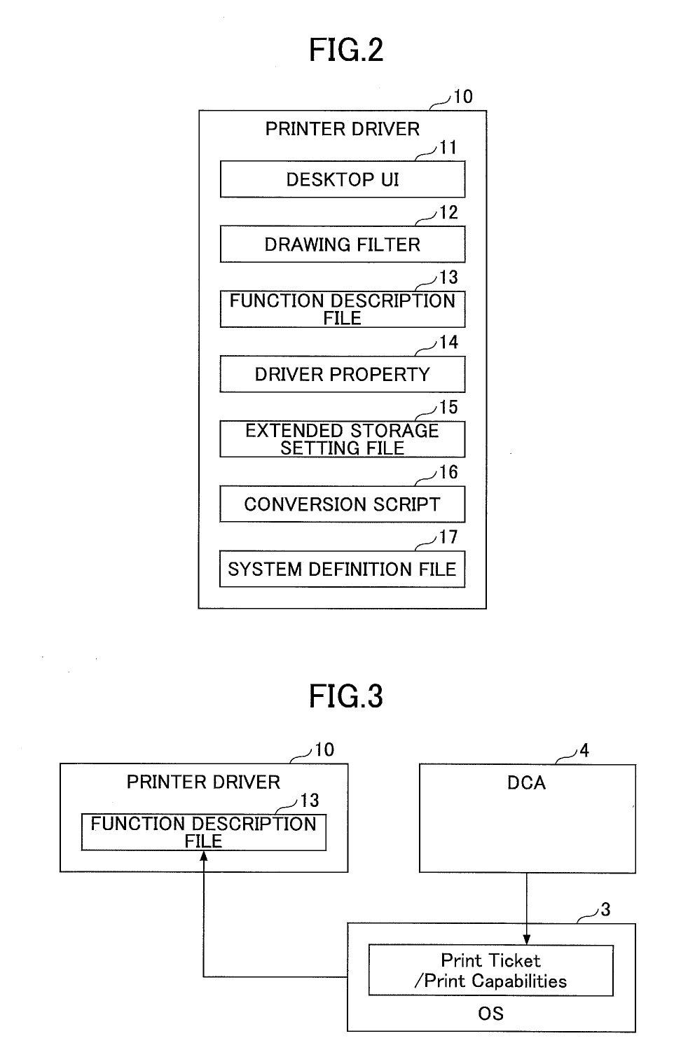

Next, with reference to FIG. 2, an example of a package configuration of a printer driver of Version 4 will be explained. The package or the printer driver 10 of Version 4 includes a desktop UI 11, a drawing filter 12, a function description file 13, a driver property 14, an extended storage setting file 15, a conversion script 16 and a system definition file 17.

The desktop UI 11 has a print setting screen displayed on a desktop side. The drawing filter 12 converts data in the standard document format (XPS) received from Windows into a format printable by a printer.

The function description file 13 is a configuration file describing the setting item of the print function and its options, and a setting for a simple prohibition. The driver property 14 holds a configuration unique to the printer driver 10. The driver property 14 can acquire content from the DCA 4 or the desktop UI 11.

The extended storage setting file 15 is a configuration file for setting a data storage location for a function which cannot be realized only with the function description file 13 when the vender wants to realize the above function. The conversion script is a file describing, when some function is added by the extended storage setting file 15, a conversion logic between their values and the PrintTicket and a logic of validation of the setting values.

The system definition file 17 describes the system configuration of the printer driver 10 and the configuration related to the installation. The system definition file 17 holds a list of the PnP IDs of the corresponding printer devices.

Next, with reference to FIG. 3, an example of acquiring the setting item of the print function by using an application of an OS standard of Windows will be explained. FIG. 3 is an example of a configuration for acquiring the setting item of the print function by using the application of the OS standard.

The Windows OS 3 reads the function description file 13 of the printer driver 10, and generates setting items which can be used by a printer. The DCA 4 can receive them as a form of PrintTicket/PrintCapabilities. In the following, the PrintTicket is called a print ticket and the PrintCapabilities is called print capabilities.

The print ticket describes a list of the setting items. When the DCA 4 or the desktop UI 11 alters the print ticket and returns it to Windows OS 3, the print setting can be changed.

The print capabilities can acquire a list of choices of setting items which can be selected, a range of a value which can be set, or a state of the prohibition. By using Windows OS 3, the validation of the print setting is performed, and the state of prohibition for the setting item can be acquired from the print capabilities. However, according to the following constraints, in the case where the print vendor intends to realize the detailed prohibitions, the print capabilities cannot respond to an actual use.

The setting of the prohibition which can be described in the function description file 13 is merely a level, such that a combination of a “choice B of function A” and a “choice D of function C” is illegal, and the print capabilities cannot respond to a more complicated description.

What can be acquired from the print capabilities is merely information that “some function is prohibited”, and there is not a method of knowing which function is prohibited according to a value of the function.

What responds to the validation is only a setting item described in the function description file 13, and a setting item appended by the extended storage setting file 15 and the conversion script 16 is not validated.

The application for the validation is quite slow, and the user must wait from when the user changes the setting on the GUI screen to when the validation result is reflected.

Accordingly, in the following embodiments, a print system will be explained which performs a process of not only the prohibition between the setting items defined preliminarily in the function description file 13 but also the prohibition between the extended setting items, and which can execute a print job based on the prohibition condition between the extended setting items.

[Whole Configuration of System]

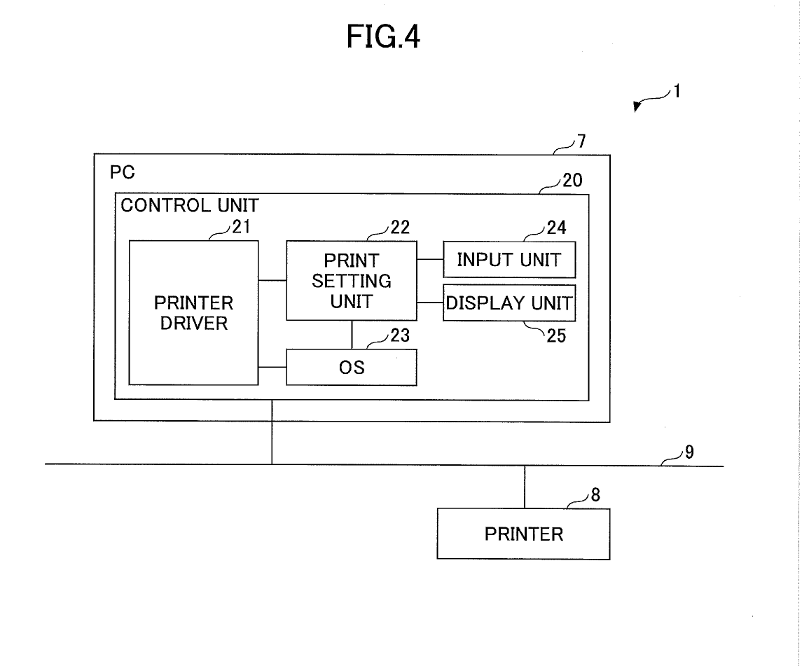

A Print System According to the Present embodiment will be explained with reference to FIG. 4. FIG. 4 is a diagram illustrating a whole configuration of the print system according to the present embodiment. In the print system 1, a PC (personal computer) 7 and a printer 8 are communicably connected via a network 9. The PC 7 can perform a print job by using the printer 7 on the network 9.

In the present embodiment, numbers of the PC 7 and of the printer 8 are one, respectively. However, plural PCs 7 or plural printers 8 may be connected to the network 9. The respective PCs 7 can exchange data with each other. Moreover, respective PCs 7 can perform print jobs by using the respective printers 8 on the network 9.

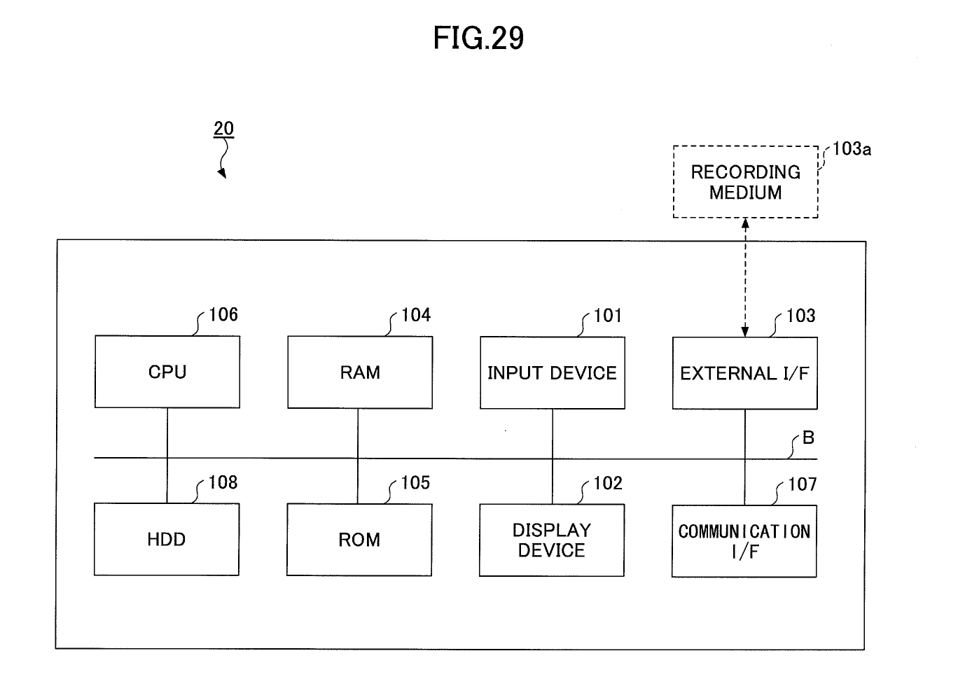

The PC 7 includes a control unit 20 realized by a microcomputer including a CPU, a ROM and a RAM (the CPU, the ROM and the RAM will be described later with reference to FIG. 29.) The control unit 20 executes a process of print control of the printer 8, and various processes according to the present embodiment. The control unit 20 includes a printer driver 21, a print setting unit 22, an OS 23, an input unit 24 and a display unit 25.

The printer driver 21 is a program stored in the ROM, and executed by the CPU, thereby a process necessary for printing, such as a setting of the print function, is performed. The print setting unit 22 is an application stored in the ROM or the RAM, and performs the print setting and display control. An OS 23 is, for example, an OS of Version 4 or the like.

The input unit 24 is an input device including a keyboard, and is a device by which the user inputs various manipulation information into the PC 7.

The manipulation information input by the input unit 24 is transmitted to the control unit 20. The control unit 20 executes various processes based on the manipulation information.

The display unit 25 is a display device including an LCD (liquid crystal display), and is a device for displaying various work screens and various information. The display unit 25 performs the display according to a control process by the control unit 20.

Meanwhile, the PC 7 is an example of an information processing apparatus according to the present embodiment, and is not limited to this. The information processing apparatus according to the present embodiment may be a tablet-type terminal or an information type terminal PDA (personal digital assistant). Moreover, the input unit 24 and the display unit 25 may be provided inside the PC 7, and may be provided outside the PC 7.

The printer 8 processes print target data based on setting information as instructed by the PC 7 for print data sent from the PC 7, and performs a print job. In the present embodiment, a case of using the printer 8 will be explained, but the printer 8 is an example of the image processing apparatus according to the present embodiment, and is not limited to this. The image processing apparatus according to the present embodiment, as long as it is provided with a print function, can be applied to an overall image processing apparatus including a facsimile apparatus, a copier, and a multifunction peripheral. The printer 8 may be a monochrome printer or a color printer. Moreover, various types of printers including an ink-jet method or an electrophotographic method may be subjects. Meanwhile, the network 9 may be various communication networks including the Internet and a local area network, and may be wired or wireless.

[Functional Configuration]

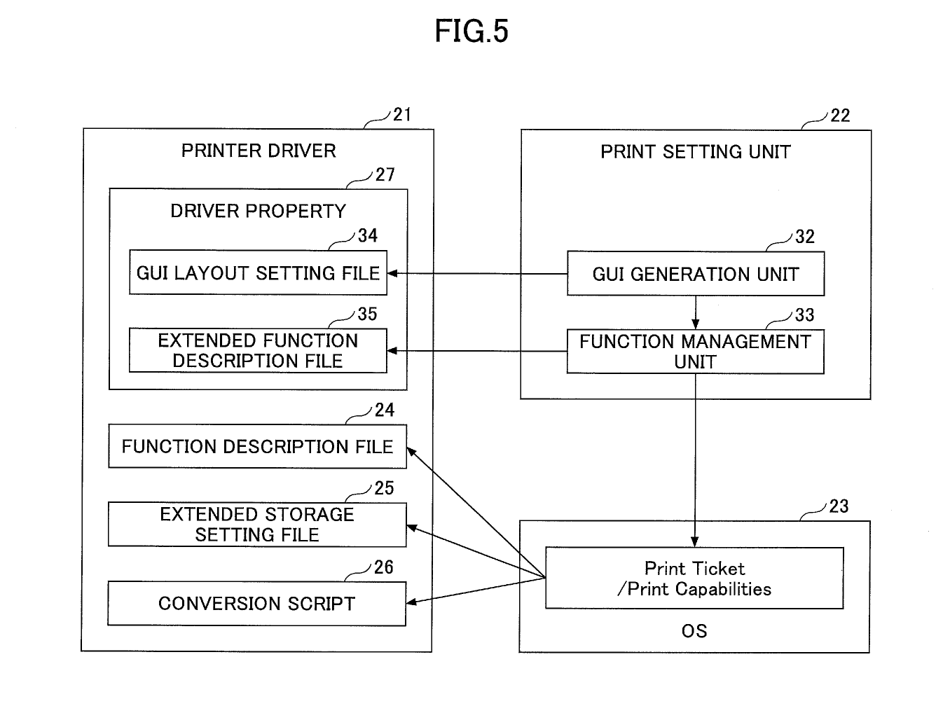

Next, a functional configuration of the printer driver and a print setting unit according to the present embodiment will be explained with reference to FIG. 5. FIG. 5 is a diagram illustrating the functional configuration of the printer driver and the print setting unit according to the present embodiment. The printer driver 21 includes a driver property 27, a function description file 24, an extended storage setting file 25 and a conversion script 26.

The function description file 24 is a setting file in which a fundamental setting item for printing is described. For example, in the function description file 24 there are a setting item of the OS standard for printing and a setting item for printing which determines a value by selecting from predetermined choices.

Moreover, in the function description file 24 a prohibition condition between the choices for the print setting items is set. For example, in the function description file 24 the prohibition condition is set by a description method such as “a combination of the choice B of the setting item A and the choice D of the setting item C is illegal”.

In the extended storage setting file 25, an identification name of data of setting item for printing that cannot be described by the function description file 24 and data, a data size of which is specified, are described. The extended storage setting file 25 is stored in a storage region which is managed by the printer driver 21.

The conversion script 26 acquires data described by the extended storage setting file 25 from the storage region, converts it into a print ticket and returns it. Moreover, the conversion script 26 receives the print ticket, and stores it in the above-described storage region. According to the configuration of the printer driver 21, as above, the print setting unit can acquire and change the setting item for printing stored in the above described storage region only by a manipulation of the print ticket.

The driver property 27 includes a GUI layout setting file 34 and an extended function description file 35. The GUI layout setting file 34 is a file in which a layout setting of a GUI screen displayed by the print setting unit 22 is described. For example, in the GUI layout setting file 34, a tab configuration, a kind of GUI, a sorting order or the like is set.

The extended function description file 35 is a file in which a prohibition between setting items for printing which cannot be described by the function description file 24 or an input prohibition is described.

The print setting unit 22 includes a GUI generation unit 32 and a function management unit 34. The GUI generation unit 32 builds a layout of GUI based on the GUI layout setting file 34 in the driver property 27, displays information on the setting items for printing acquired from the function management unit 33, and provides a manipulation unit for the user. Meanwhile, the GUI generation unit 32 is an example of a display control unit that displays an image for receiving a setting related to a print process which is required in the image processing apparatus based on extended print setting information, which will be described later.

The function management unit 33 adds the prohibition information among the setting items described in the extended function description file 35 and the input prohibition information to the information on the setting item for printing acquired from the PrintTicket/PrintCapabilities of the OS 23, builds information on the final setting item for printing, and presents it to the GUI. In the following, the PrintTicket will be called a print ticket, and the PrintCapabilities will be called print capabilities. The function management unit 33, when the print setting on the UI is changed by the user, receives it, and updates a value of the print ticket setting item. This function management unit 33 is an example of a receiving unit that receives a setting related to a print process based on the screen displayed by the display control unit.

In the print ticket a list of values of print setting items is described. When the setting value is changed and sent to the OS 23, the print setting is changed. In the print capability of the OS 23, a list of selectable choices of the setting items or a range of a value which can be set or a state of the prohibition is described.

(Function Description)

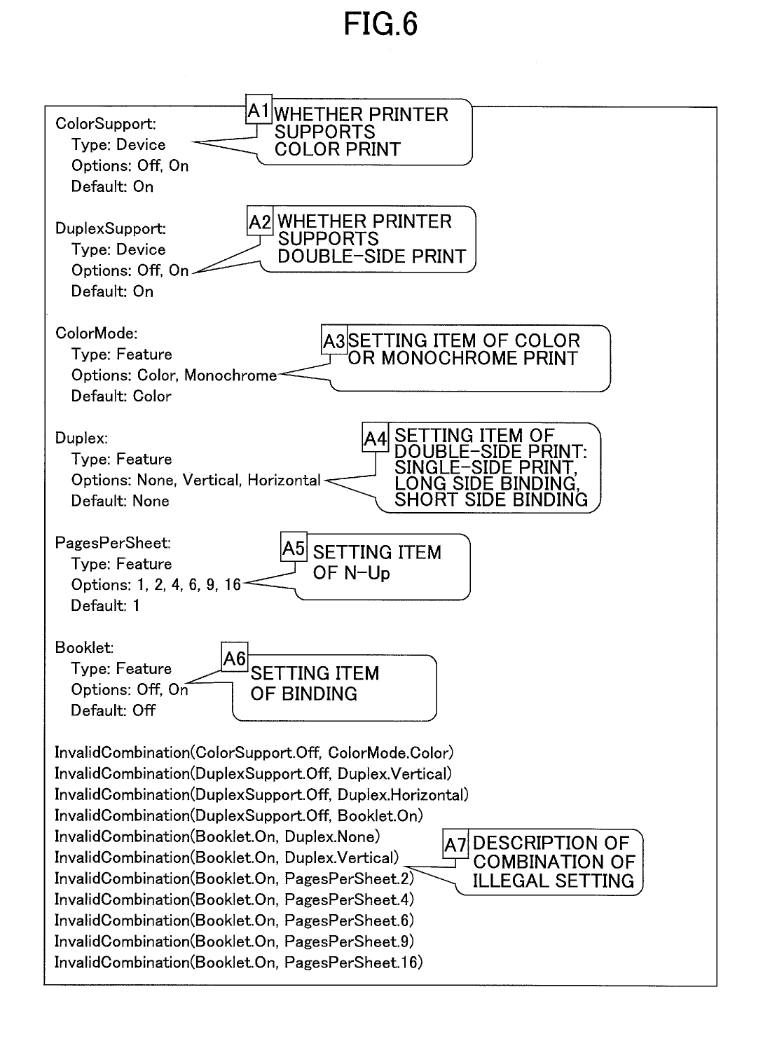

FIG. 6 is a diagram illustrating an example of the function description file 24. In the function description file 24, a list of functions that can be used in the driver and illegal combinations are described. Meanwhile, information described in the function description file 24 is an example of function description information which shows plural setting items related to functions of the image processing apparatus and prohibitions in the plural setting items.

For example, “A1” shows a function description for a setting item whether the printer 8 supports a color print. “A2” is a function description for a setting item whether the printer 8 supports a double-side print. “A3” is a function description for a setting item of the color or monochrome print. “A4” is a function description for setting item of the double-side print. A single-side print, a long side binding, a short side binding or the like can be set.

“A5” is a function description for a setting item of N-up (N is a number of pages printed in a sheet). “A6” is a function description for a setting item of binding. “A7” is a description of the prohibition conditions which are combinations of illegal settings.

In the function description file 24, in each function item, settings of Type, Options and Default are described. Type describes whether the setting item is a print setting (Feature) or a device setting (Device). Options describe a list of choices of setting items. Default describes a default value of a setting item.

FIG. 6 describes that a combination of (setting items, setting values) listed in the parenthesis of InvalidCombination of “A7” is illegal.

(Extended Storage Setting)

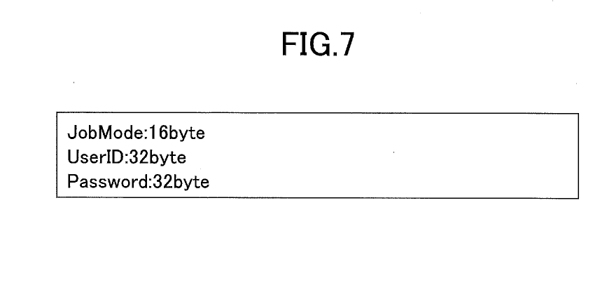

FIG. 7 is a diagram illustrating an example of the extended storage setting file 25. In this example, items JobMode, UserID and Password are assumed to be added. JobMode is an item to set how to treat a print job, and it is assumed that there are choices of NormalPrint (printing normally), SecurePrint (printing requiring a username and a password when printing) and StoreImage (not outputting on a paper, but storing an image in the printer and printing afterward). The extended storage setting file 25 declares the setting items which are not described in the function description file 24 as well as the storage size of the data.

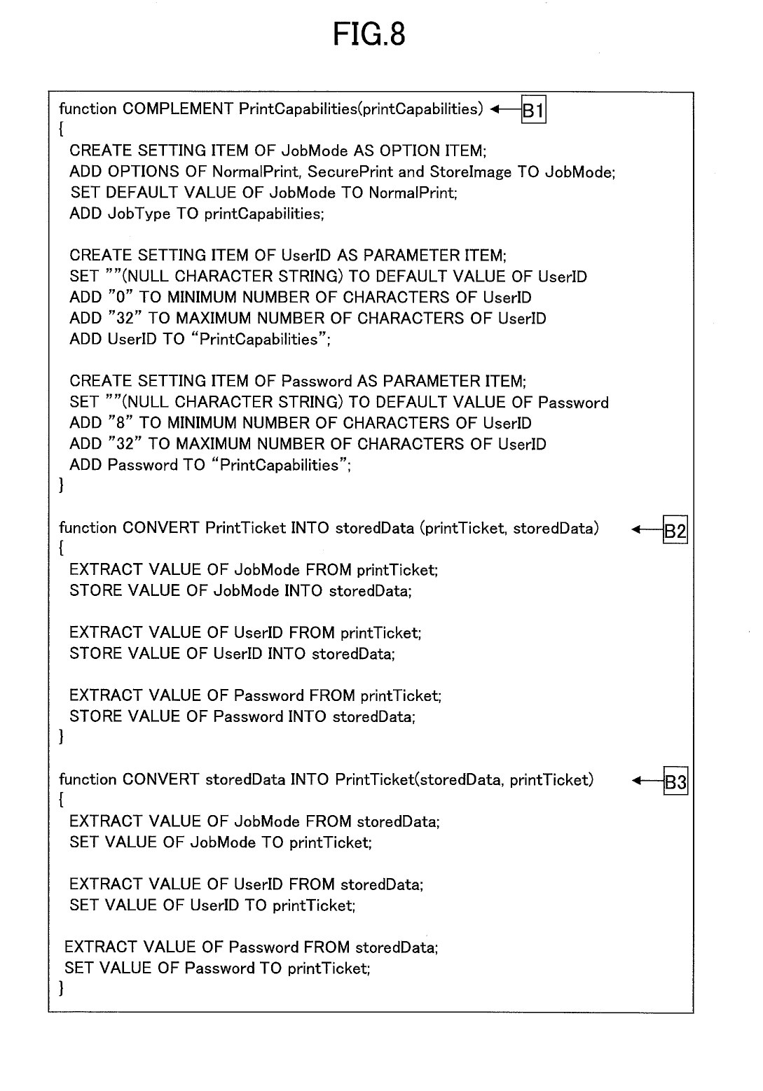

In the conversion script 26, for the setting items declared by the extended storage setting file 25, each process as shown in FIG. 8 is described. In “B1” in FIG. 8, a process of adding a setting item extended to the print capabilities is described. In “B2” in FIG. 8, a process of extracting a value of a setting item extended from the print ticket, and storing it in storage data is described. In “B3” in FIG. 8, a process of extracting a value of a setting item extended from the stored data, and setting it in a print ticket is described.

When these processes are described, at a timing of generating the print capabilities, at a timing of storing the print ticket, and at a timing of generating the print ticket, the OS 23 calls, respectively.

Meanwhile, the information described in the extended storage setting file 25 and the conversion script 26 is an example of additional function information showing information for requesting from the image processing apparatus a function different from the function of the plural setting items shown in the function description information.

(Device Setting Screen)

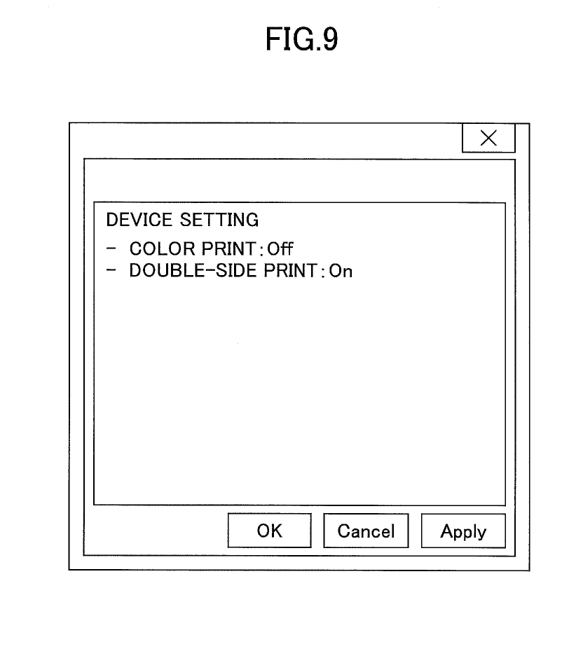

FIG. 9 is an example of a device setting screen. OS 23 reads the function description file 24 shown in FIG. 6, and a list of setting item where Type is Device is displayed on a device setting screen. Accordingly, the user can change the device setting. In this example, the part where “Color Support” is described in the function description file 24 corresponds to “color print” and set to “Off”. Moreover, the part where “DuplexSupport” is described in the function description file 24 corresponds to “double-side print” and is set to “On”. In these settings, the printer 8 functions as a monochrome printer device which can perform double-side printing.

(Print Capability/Print Ticket)

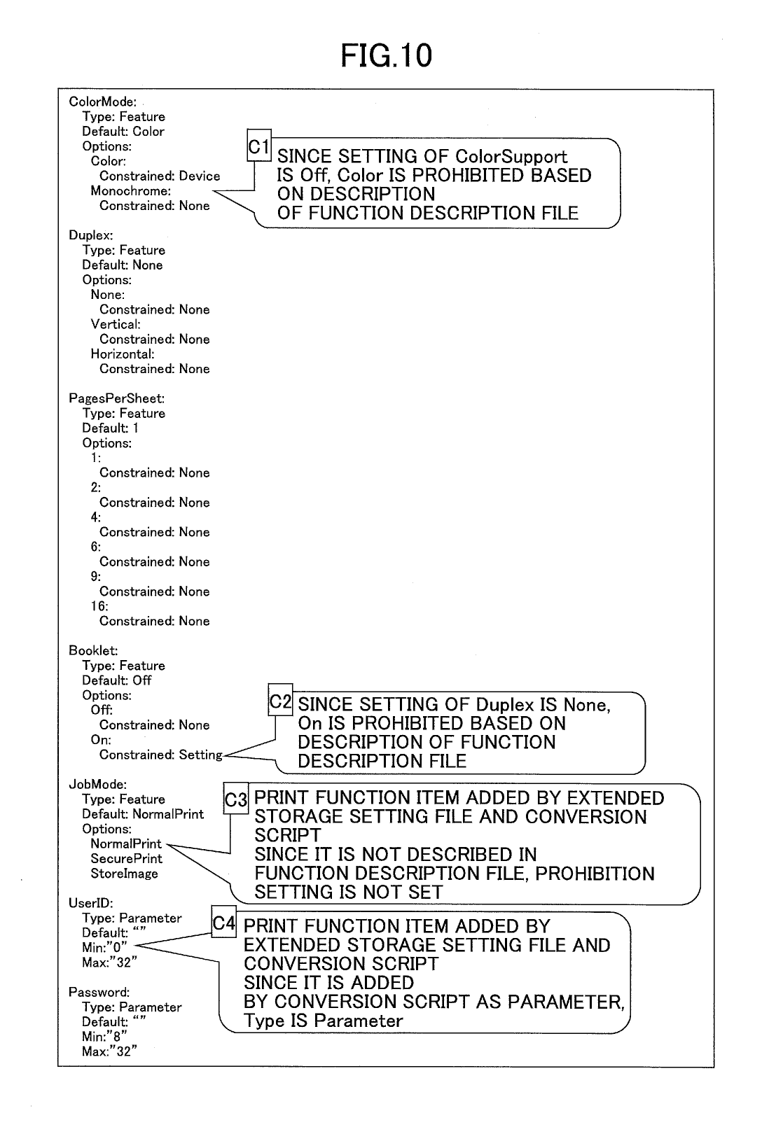

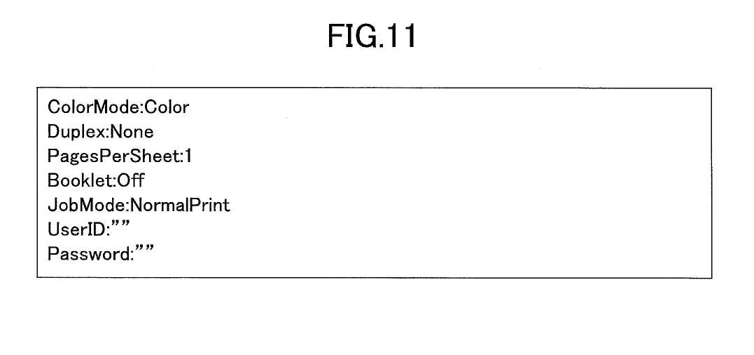

Next, the print capability and the print ticket will be explained with reference to FIGS. 10 and 11. FIG. 10 illustrates an example of the print capability. FIG. 11 illustrates an example of the print ticket.

If the values of the print setting items remain default values, the OS 23 generates a print capability and a print ticket as shown in FIGS. 10 and 11 based on the function description files 24, the extended storage setting file 25, the conversion script 26, the device setting and the print setting. Meanwhile, a unit that generates the print capability and the print ticket by the OS 23 based on the function description file 24, the extended storage setting file 25, the conversion script 26 or the like is an example of the first generation unit that generates process information related to a process which requires the image processing apparatus based on the function description information and the additional function information.

In the print capability, related to the print setting items which can be used, the following information can be acquired.

Type: the kind of the print setting item is an option (“Feature”) or a parameter (“Parameter”);

Default: default value of the print setting item;

Options: a list of options of the print setting items;

Constrained: Reason of prohibition of the print setting item (None: no prohibition, Setting: other setting items and Device: device setting); and

Min, Max: a minimum number of characters of the parameter and a maximum number of characters of the parameter.

In the function description, the item where Type is Device is not included in the print capability.

For example, as described above, the part described as “Color Support”, shown by A1 in FIG. 6, is set “Off”. Accordingly, since the setting of “ColorSupport” is “Off”, “Color” in “ColorMode” shown by “C1” in FIG. 10 is prohibited, based on the function description shown by A7 in FIG. 6.

Moreover, since the setting of “Duplex” shown by A4 in FIG. 6 is set “None”, “On” in “Booklet” shown by “C2” in FIG. 10 is prohibited based on the function description shown by A7 in FIG. 6.

Moreover, the description “JobMode” of “C3” in FIG. 10 is a print setting item appended by the extended storage setting file 25 and the conversion script 26 shown in FIG. 8, and is not described in the function description file 24 of FIG. 6. Accordingly, a prohibition is not set.

Moreover, the description of “UserID” of “C4” in FIG. 10 is a print setting item appended to the extended storage setting file 25 and the conversion script 26 shown in FIG. 8, and appended as a parameter in the conversion script in FIG. 8. Accordingly, “Type” of “UserID” of “C4” in FIG. 10 is “Parameter”.

The print ticket shown in FIG. 11 includes a list of present setting values of the print setting items.

(Print Capability/Print Ticket where the Setting Value is Changed)

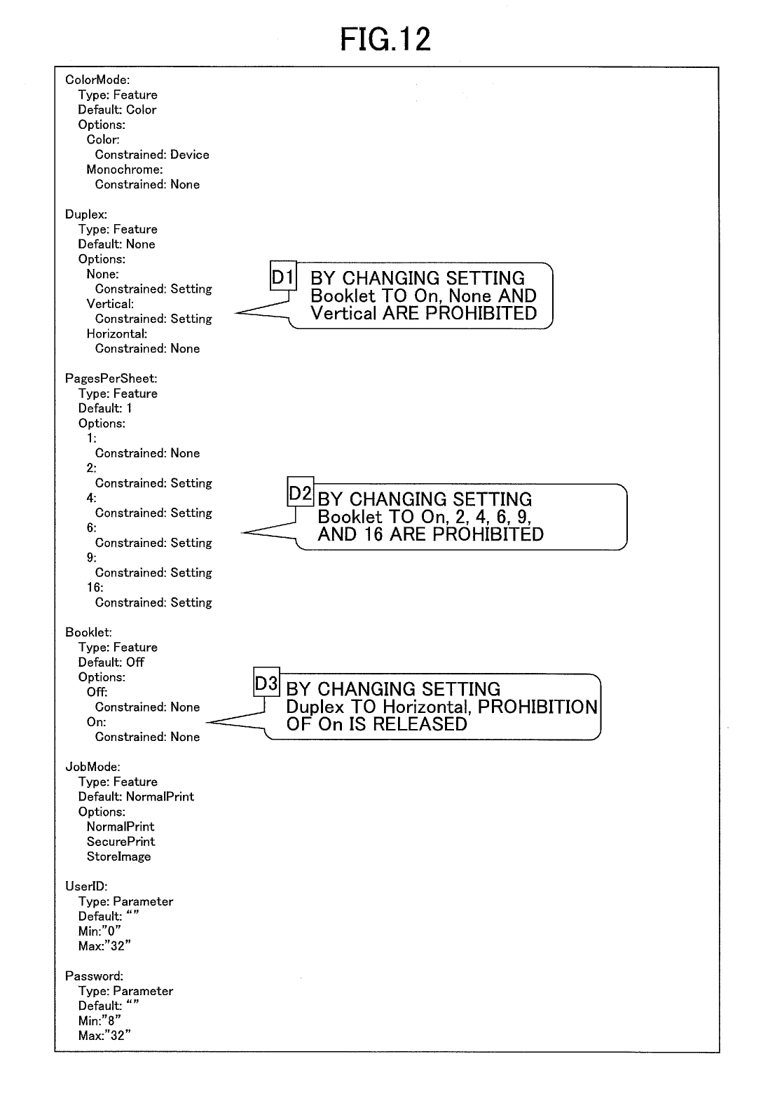

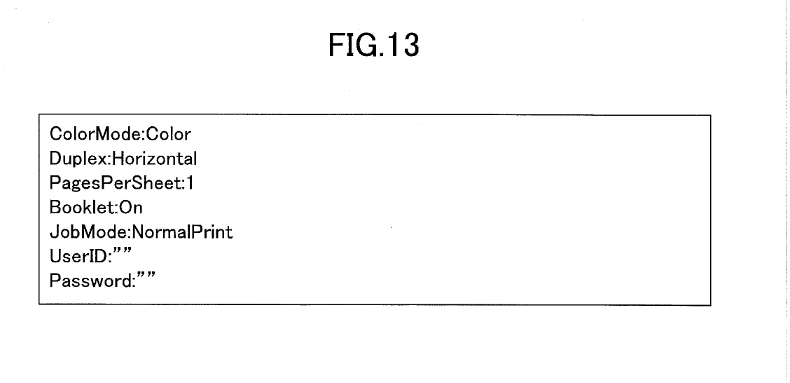

Next, the print capability and the print ticket where the setting value is changed will be explained with reference to FIGS. 12 and 13. FIG. 12 illustrates an example of the print capability where the setting value is changed. FIG. 13 illustrates an example of the print ticket where the setting value is changed.

FIG. 12 illustrates a print capability and a print ticket obtained by changing the value of “Duplex” to “Horizontal” and the value of “Booklet” to “On” from the state shown in FIG. 10.

Specifically, by changing the setting “Booklet” to “On”, “None” and “Vertical” shown by “D1” in FIG. 12 are prohibited based on the prohibition condition of “A7” in FIG. 6.

Moreover, by changing the setting “Booklet” to “On”, “2”, “4”, “6”, “9”, “16” in “PagesPerSheet” show by “D2” in FIG. 12 are prohibited based on the prohibition condition of “A7” in FIG. 6.

Moreover, by changing the setting “Duplex” to “Horizontal”, the prohibition for “On” of “Booklet” shown by “D3” in FIG. 12 is released.

FIG. 13 illustrates a print capability and a print ticket obtained by changing the value of “Duplex” to “Horizontal” and the value of “Booklet” to “On” from the state shown in FIG. 11.

(Extended Function Description)

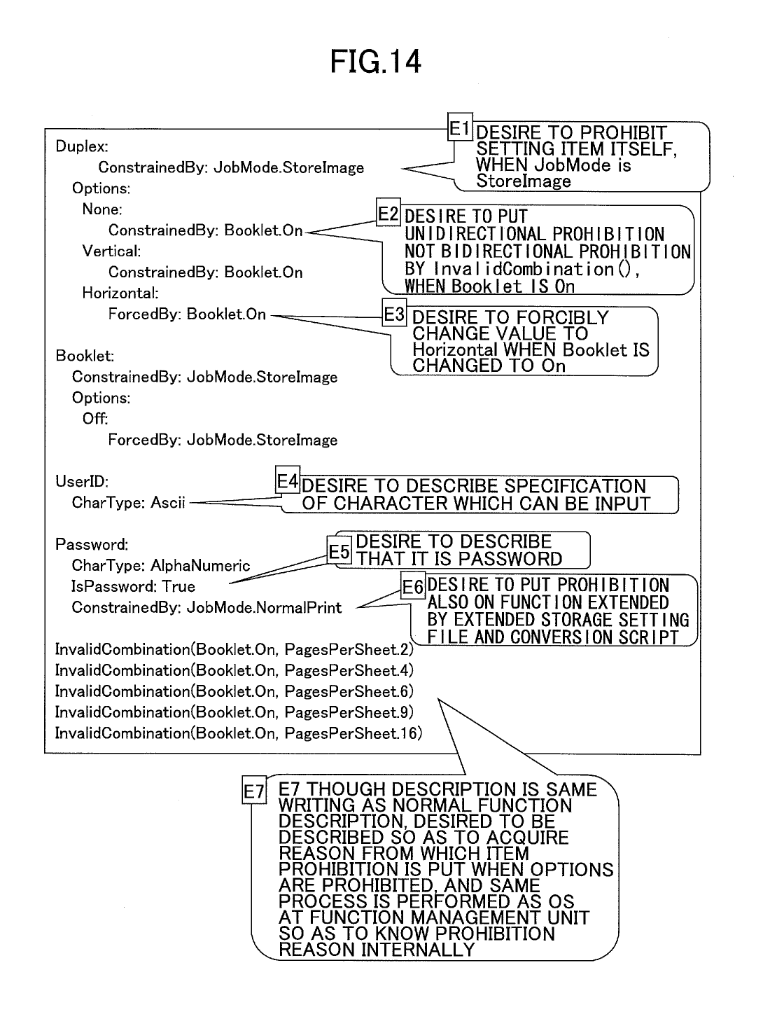

Next, the extended function description by the extended function description file 35 will be explained with reference to FIG. 14. FIG. 14 illustrates an example of the extended function description file 35. The extended function description file 35 describes a specification of the function which cannot be described with the normal function description or the setting of the prohibition. As an example, the following description becomes possible.

ConstrainedBy: used for describing a unidirectional prohibition which is a bidirectional prohibition in “InvalidCombination” of the function description; and

ForcedBy: when a value of the other setting item is changed to a specific value, described in order to forcibly change the value.

CharType: describes a specification of characters which can be input, in a setting item of inputting a character string;

IsPassword: in the setting item of inputting a character string, describes whether it corresponds to a password.

According to the above features, description of setting of prohibition becomes possible not only for the options but also for the setting items.

In “E1” in FIG. 14, when “JobMode” is “StoreImage”, in order to prohibit the setting item itself, an extended function is described using “ConstrainedBy”.

In “E2” in FIG. 14, when “Booklet” is “On”, in order to put a unidirectional prohibition, not a bidirectional prohibition by “InvalidCombination( )”, an extended function is described using “ConstrainedBy”.

In “E3” in FIG. 14, when “Booklet” becomes “On”, in order to change the value to “Horizontal” forcibly, an extended function is described using “ForcedBy”.

In “E4” in FIG. 14, in order to describe the specification of characters which can be input, an extended function is described using “CharType”.

In “E5” in FIG. 14, in order to describe that a password is input, an extended function is described using “IsPassword”.

In “E6” in FIG. 14, in order to put prohibition also on a function extended by the extended storage setting file 25 and the conversion script 26, an extended function is described using “ConstrainedBy”.

In “E7” in FIG. 14, the description is the same writing as the normal function description, but the same process is performed as the OS 23 at the function management unit 33 so as to acquire a reason from which item the prohibition is put when options are prohibited, and the prohibition condition is described so as to know the prohibition reason internally.

Meanwhile, information described in the extended function description file 35 is an example of extended function description information indicating a prohibition different from the prohibition indicated by the function description information.

[Sequence of Startup of GUI/Change of Setting Value]

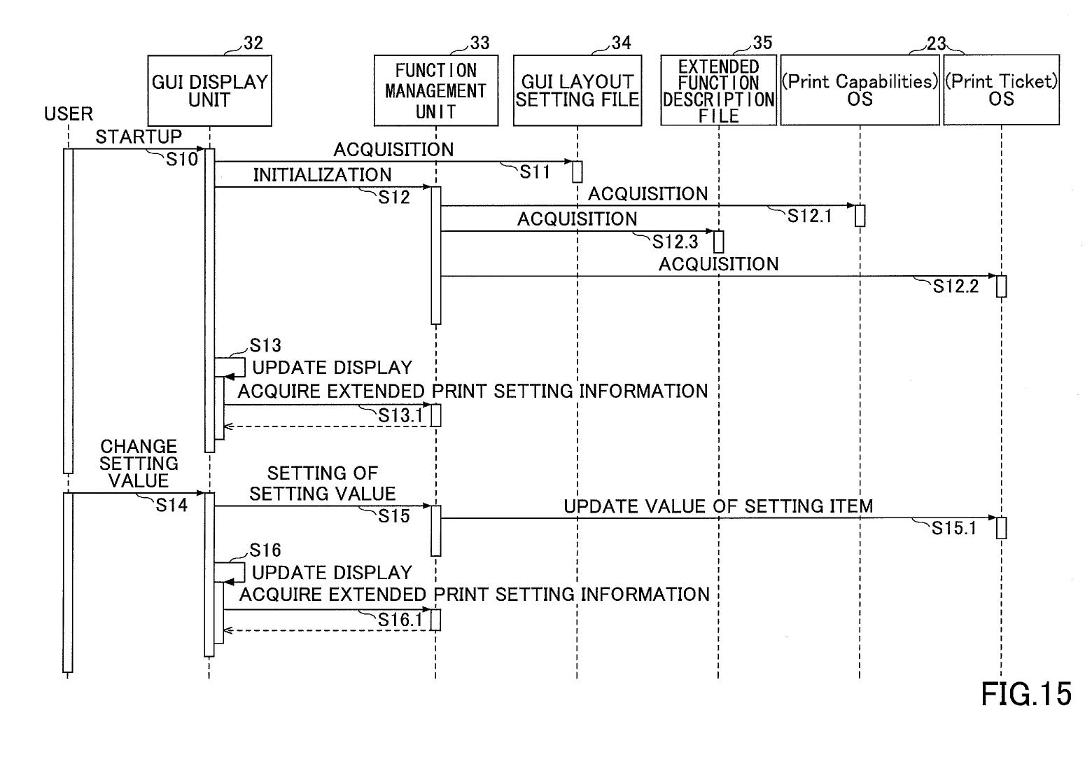

Next, a sequence of a startup of the GUI according to the present embodiment and a change of the setting value by a user will be explained with reference to FIG. 15. FIG. 15 is a sequence diagram illustrating a process of starting a GUI by a GUI generation unit 32 according to the present embodiment and a process of changing the setting value by the user according to the present embodiment on the GUI screen which has been started up.

(Sequence at the Time of Start-Up)

When the GUI screen is started up by the user (step S10), the GUI generation unit 32 acquires a GUI layout setting from the GUI layout setting file (step S11). The GUI generation unit 32 uses the acquired GUI layout setting when the display is updated.

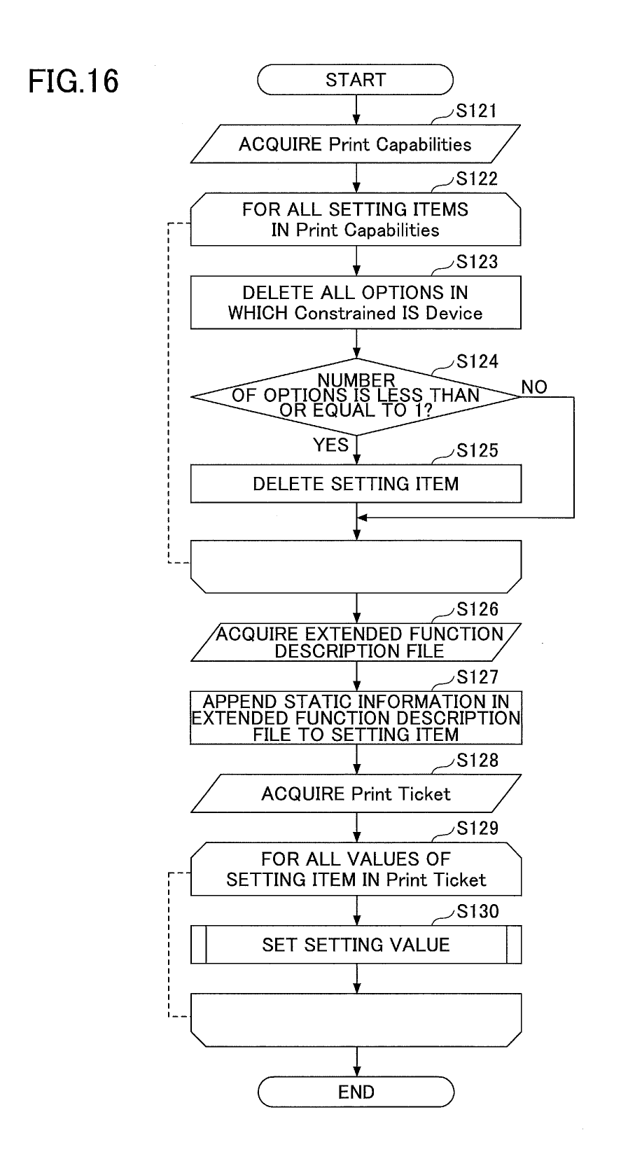

Next, the GUI generation unit 32 initializes the function management unit 33 (step S12). In this initialization process, the function management unit 33 acquires the print capability and the print ticket generated by the OS 23 (step S12.1 and step S12.2), and acquires an extended function description from the extended function description file 35 (step S12.3). Details of the initialization process of the function management unit 33 will be explained later with reference to FIG. 16.

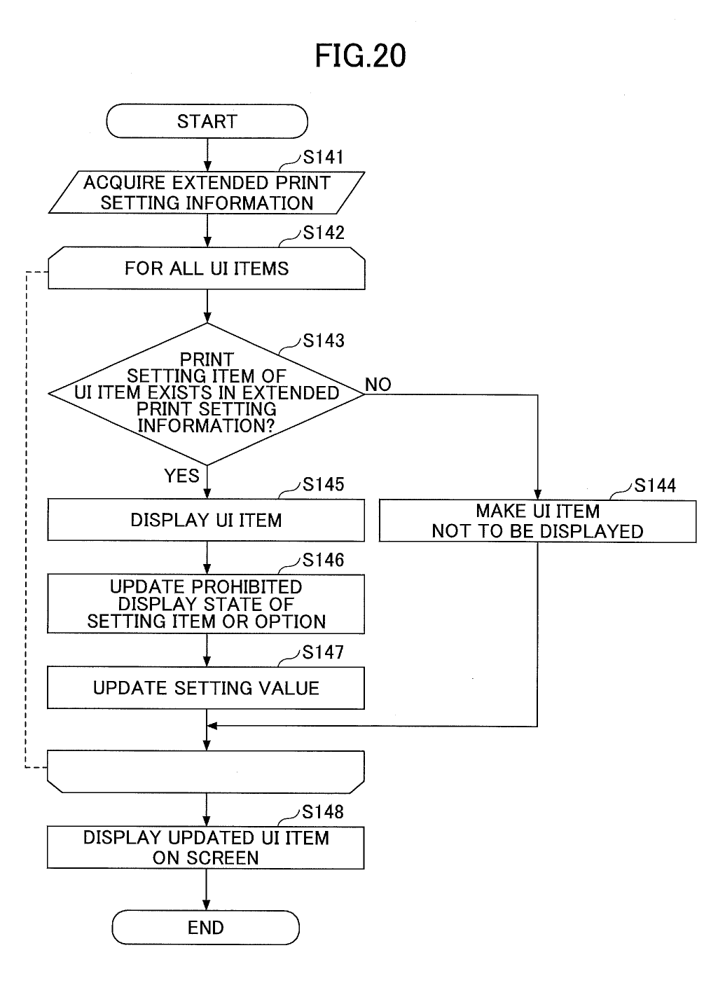

After the initialization process of the function management unit 33 is completed, the GUI generation unit 32 performs the process of updating the display (step S13). In this process, extended print setting information is acquired (step S13.1), and a display of a GUI screen is updated. The extended print setting information is information generated by the function management unit 33 and indicating states of the respective setting items. Meanwhile, details of this process will be explained later with reference to FIG. 20.

(Sequence at the Change in Setting)

When the print setting on the UI is changed by the user (step S14), the GUI generation unit 32 instructs the function management unit 33 to set setting values of the setting items (step S15). The function management unit 33 updates a value of the print ticket setting item (step S15.1). Details of these processes will be explained later with reference to FIG. 16.

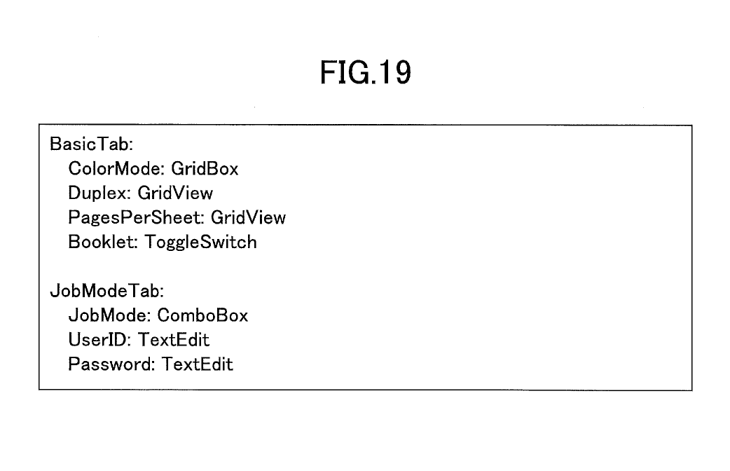

After the process of changing the setting of the function management unit 33 is completed, the GUI generation unit 32 performs the process of updating the displaying of the GUI screen (step S16). In this process, the GUI generation unit 32 acquires the extended print setting information (step S16.1), and updates the displaying of the GUI screen. Details of this process will be explained later with reference to FIG. 19.

[Initialization Process of Function Management Unit]

Next, the initialization process of the function management unit 33 according to the present embodiment will be explained with reference to FIG. 16. FIG. 16 is a flowchart illustrating an example of the initialization process by the function management unit 33 according to the present embodiment.

At first, the function management unit 33 acquires the print capability (step S121). In the example shown in FIG. 16, the function management unit 33 executes the following processes from step S123 to step S125 for all the setting items in the print capability (step S122).

In the setting item in which “Type” is “Feature”, all the options in which “Constrained” is “Device” are deleted (step S123). In the case where a number of options is less than or equal to one as a result of the deletion (step S124), the function management unit 33 deletes the setting item itself (step S125). According to the above deletion, an item or an option which is prohibited by a device is not displayed to the user from the beginning.

Next, the function management unit 33 acquires the extended function description file 35 (step S126). The function management unit 33 appends static information in the extended function description file 35 to the respective setting items (step S127). The static information means information a state of which does not change dynamically despite the prohibition process, such as “CharType” or “IsPassword” in the extended function description.

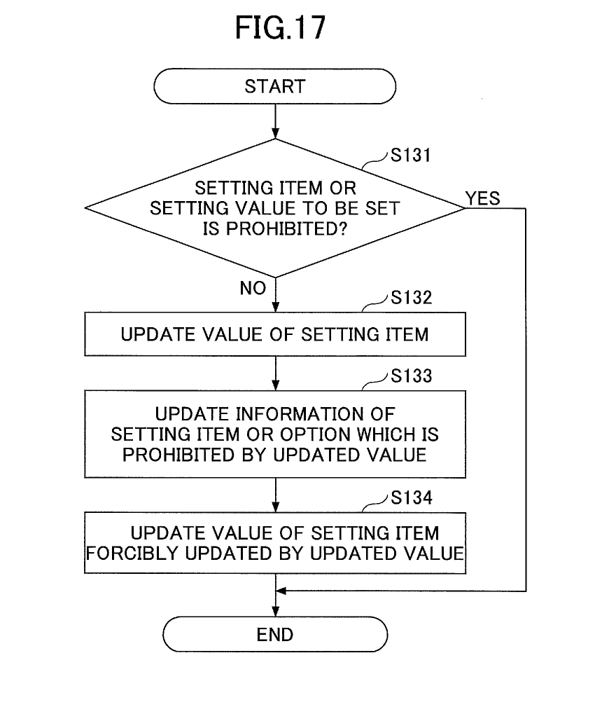

Next, the function management unit 33 acquires the print ticket (step S128). The function management unit 33 calls the process routine of “setting process of setting value” shown in FIG. 17 for all the values of the setting items in the print ticket (steps S129 and S130). According to the above process, initial values and initial states of prohibitions can be set.

(Setting Process for Setting Value)

A setting process of a setting value called at step S130 will be explained with reference to FIG. 17. FIG. 17 is a flowchart illustrating the setting process of a setting value at the function management unit 33.

The function management unit 33 determines whether the setting item or the setting value to be set is prohibited by the prohibition condition based on the description of the extended function description file 35 (step S131). When it is determined to be prohibited, the setting process ends without executing the further processes. Accordingly, a change to the prohibited setting item or the prohibited setting value is prohibited.

When it is determined not to be prohibited, the function management unit 33 updates the value of the setting item to the setting value to be set (step S132). Next, the function management unit 33 searches for a prohibition arising by the setting value updated at step S132, based on the description of the extended function description file 35, and updates information of the setting item to be prohibited (step S133).

The function management unit 33 searches for a setting item, a value of which is forcibly changed by the value updated at step S132 based on the description of the extended function description file 35, and updates the value of the setting item (step S134). The setting value set by the function management unit 33 is an example of the extended print setting information. Meanwhile, the function management unit 33 is an example of a second generation unit that generates the extended print setting information for displaying screen reflecting the prohibition indicated by the extended function description information based on the extended function description information and the process information generated by the first generation unit. Moreover, the function management unit 33 includes a function of the second generation unit that generates, based on a comparison between a setting received by the function management unit 33 and the function extended description information, the extended print setting information reflecting the prohibition related to the received setting.

(Extended Print Setting Information)

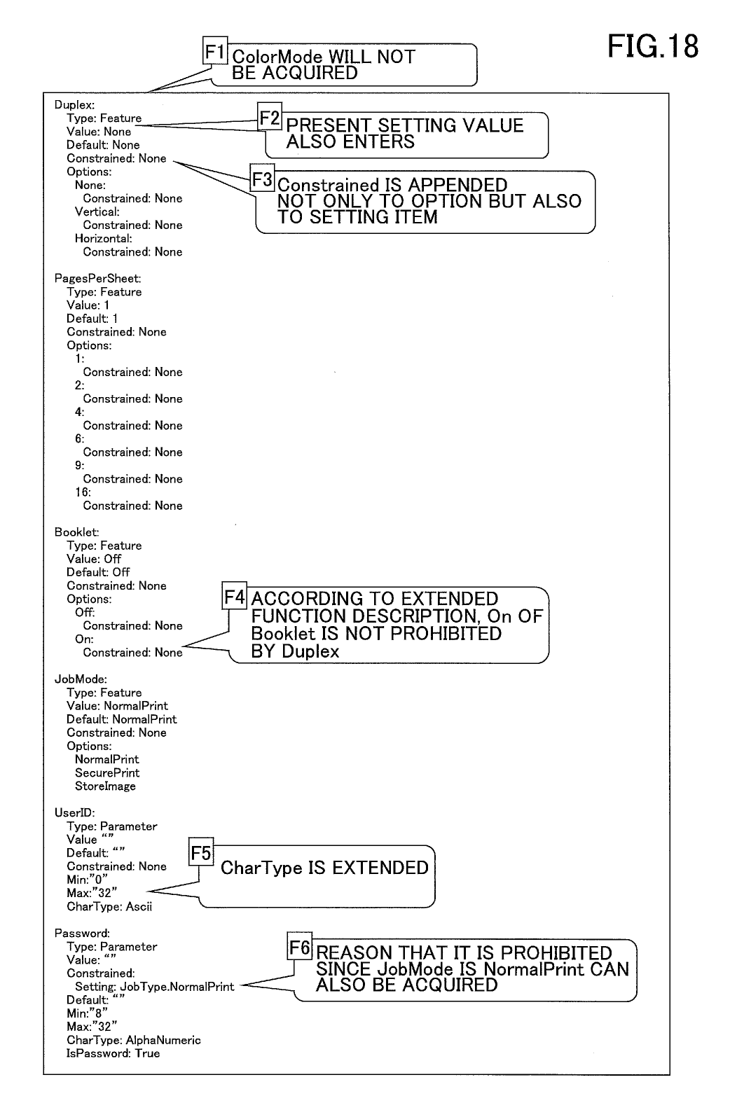

Next, an example of the extended print setting information which can be acquired by the function management unit 33 will be explained with reference to FIG. 18. FIG. 18 illustrates an example of the extended print setting information. The function management unit 33 can acquire states of respective setting items generated by the process shown in FIG. 16 or FIG. 17. Examples are shown in the following:

Type: value indicating whether the kind of the print setting item is an option (Feature) or a parameter (Parameter);

Value: present setting value of the print setting item;

Default: default value of the print setting item;

Options: list of the options of the print setting items;

Constrained: reason of prohibition for the print setting item (None: no prohibition, Setting: other setting item, Device: device setting). A reason of prohibition is described not only for the options but also for the setting items. When the reason of prohibition is “Setting”, it describes from which value and of which setting item the print setting item is prohibited;

Min, Max: the minimum or maximum number of characters of the parameter;

CharType: setting item that makes the user input a character string, and describes the specification of characters that can be input. The GUI generation unit 32 executes the process of prohibiting an input of illegal characters referring to this setting item; and

IsPassword: setting item that makes the user input a character string, and describes whether it corresponds to a password. The GUI generation unit 32 performs a process of putting a mask on the password character string referring to this setting item.

For example, in the extended printing setting information shown in FIG. 18, a description of “ColorMode” does not exist, as shown by “F1” in a margin, “ColorMode” will not be acquired.

In “F2”, since “Value” is “None”, the setting process is performed also with the present setting values.

In “F3”, “Constrained” is appended not only to the options but also to the setting items.

In “F4”, according to the description of the extended function description file 35, “On” of “Booklet” is not prohibited by “Duplex”.

In “F5”, “CharType” is extended.

In “F6”, a reason that it is prohibited since “JobMode” is “NormalPrint” is also acquired.

(GUI Layout Setting)

A GUI layout setting file 34 is a file describing a setting of the GUI layout. FIG. 19 illustrates an example of the GUI layout setting.

[Process of Updating Display of GUI Screen]

Next, the process of updating the displaying of the GUI screen according to the present embodiment will be explained with reference to FIG. 20. FIG. 20 is a flowchart illustrating an example of the process of updating the display of the GUI screen according to the present embodiment.

The GUI generation unit 32 updates the displaying of the GUI screen based on the extended print setting information acquired from the function management unit 33 and the GUI layout setting acquired from the GUI layout setting file 34.

The process of updating the displaying executed by the GUI generation unit 32 is performed according to the following procedures. Meanwhile, the GUI generation unit 32 acquires and holds the GUI layout setting in advance (step S11 in FIG. 15).

The GUI generation unit 32 acquires the latest extended print setting information (step S141). The GUI generation unit 32 executes the following processes of step S143 to step S146 for all the UI items on the GUI layout setting (step S142). The GUI generation unit 32 determines whether a print setting item of the UI item exists in the extended print setting information (step S143). When it is determined that the print setting item does not exist, the GUI generation unit 32 does not display the UI item, and the display space for the UI item on the GUI screen is removed (step S144). Accordingly, the item that the user cannot change is not displayed, the screen does not include an empty space, and the user can use device without feeling strangeness.

On the other hand, when it is determined that the print setting item exits, the GUI generation unit 32 displays the UI items according to the UI kinds (GridView, ComboBox, ToggleSwitch, TextEdit or the like) of the GUI layout setting (Step S145). Next, the GUI generation unit 32 updates a prohibited display state, such as a gray down display, of the UI item according to the information of “Constrained” in the extended print setting information (step S146). Next, the GUI generation unit 32 updates the setting value of the UI item according to the information of “Value” in the extended print setting information (step S147).

Finally, the GUI generation unit 32 displays an image, on which the updated UI items are displayed, on the screen (step S148).

According to the procedure, as stated above, the UI items which are not necessary to be presented to the user become not displayed. When the user changes the setting, the states of the UI items, prohibitions or values of which are changed by the change of the setting, are updated.

(Example of Display of GUI Screen)

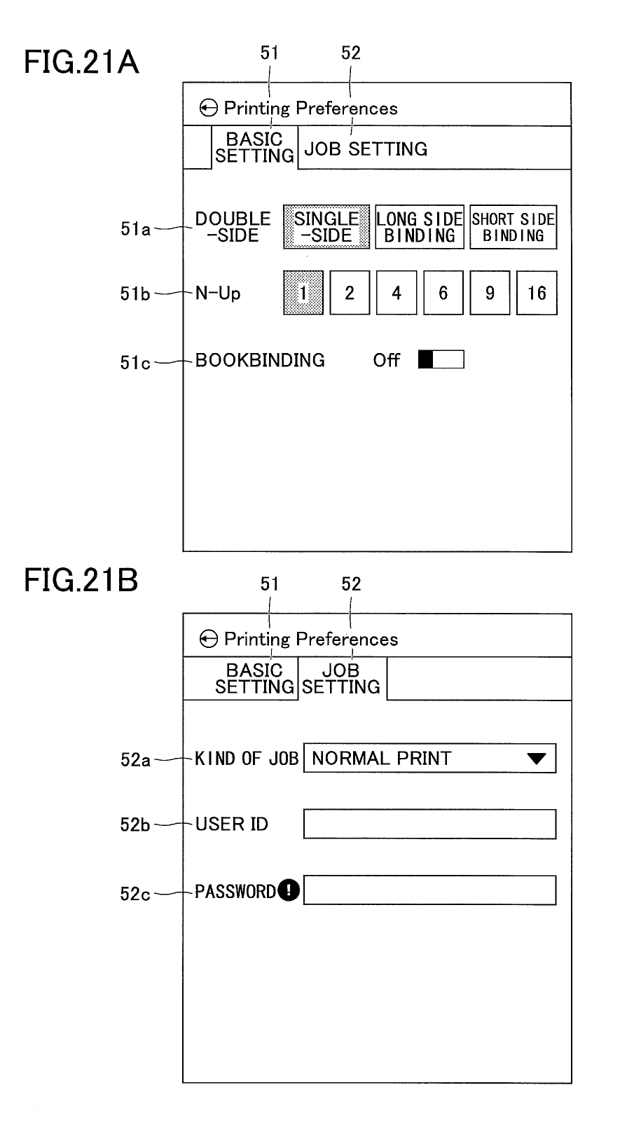

An example of the displaying of the GUI screen according to the present embodiment is shown in FIGS. 21A and 21B. The examples of the screen shown in FIGS. 21A and 21B are displayed based on the extended print setting information in FIG. 18 and the GUI layout setting in FIG. 19. According to the description of “BasicTab” and “JobModeTab” in the GUI layout setting, a basic setting tab and a job setting tab are displayed.

In the basic setting tab shown in FIG. 21A, since “ColorMode” described in the GUI layout setting is not described in the extended print setting information, “ColorMode” becomes not displayed and a display space is removed. “Duplex (double-side)” 51a, “PagesPerSheet (N-up)” 51b, “Booklet (bookbinding)” 51c are displayed according to the UI kinds described in the GUI layout setting.

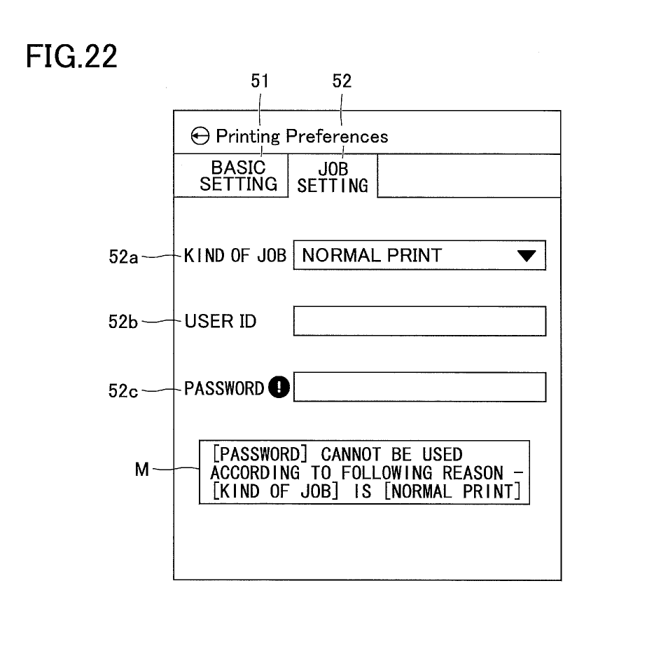

In the Job Setting Tab Shown in FIG. 21B, “JobMode (kind of jobs)” 52a, “UserID (User ID)” 52b, “Password (password)” 52c are displayed. “Password” 52c is prohibited by “NormalPrint” of “JobType”, and is displayed in gray down. The user's input is prohibited. Moreover, a prohibition reason display icon (!) is displayed. When the user clicks the prohibition reason display icon, the GUI generation unit 32 acquires the reason of prohibition from the extended print setting information. Consequently, as shown in FIG. 22, a message M of the reason of prohibition is displayed on the screen.

(First Other Example of Extended Print Setting Information)

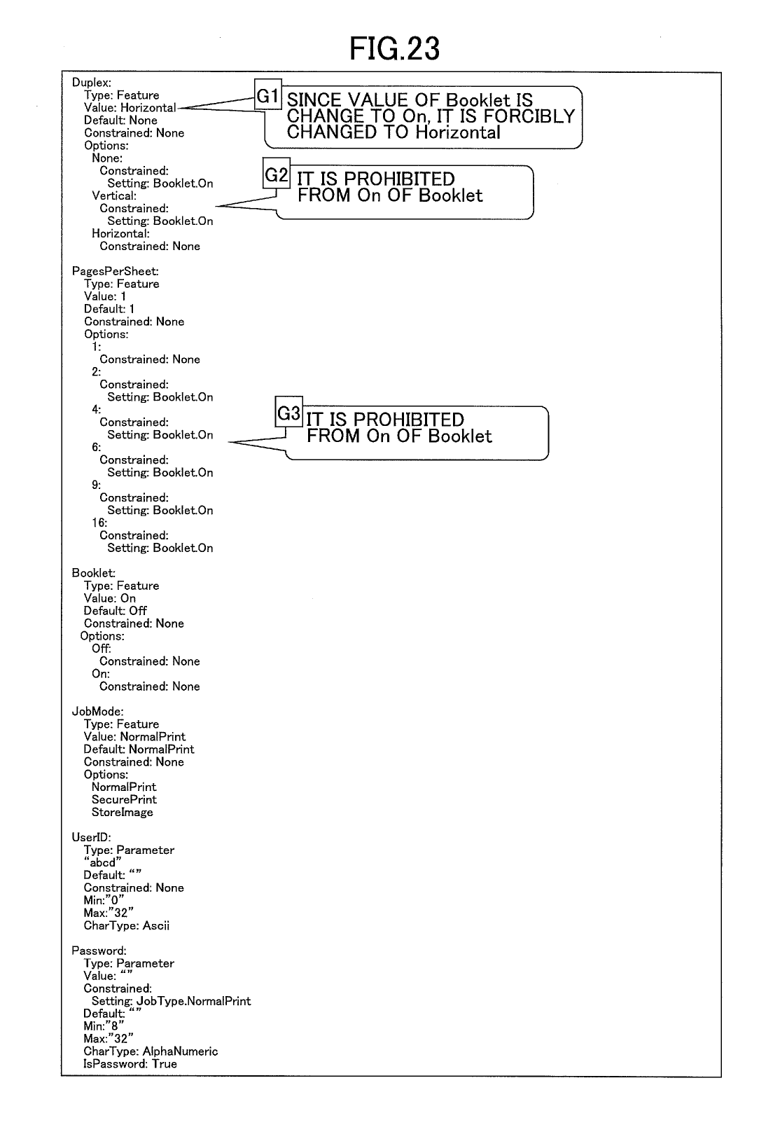

Next, a first other example of the extended print setting information will be explained with reference to FIG. 23. FIG. 23 illustrates an example of the extended print setting information in which “Booklet” is changed to “On” and a value of “abcd” is input to “UserID”.

Since the value of “Booklet” is changed to “On”, according to the description of the extended function description file 35, in “G2” in FIG. 23, “None” and “Vertical” in “Duplex” are prohibited and become unusable, and in “G1”, the setting value of “Duplex” is forcibly changed to “Horizontal”.

Moreover, in “G3”, “2”, “4”, “6”, “9” and “16” in “PagesPerSheet” are prohibited.

(First Example of Display of GUI Screen)

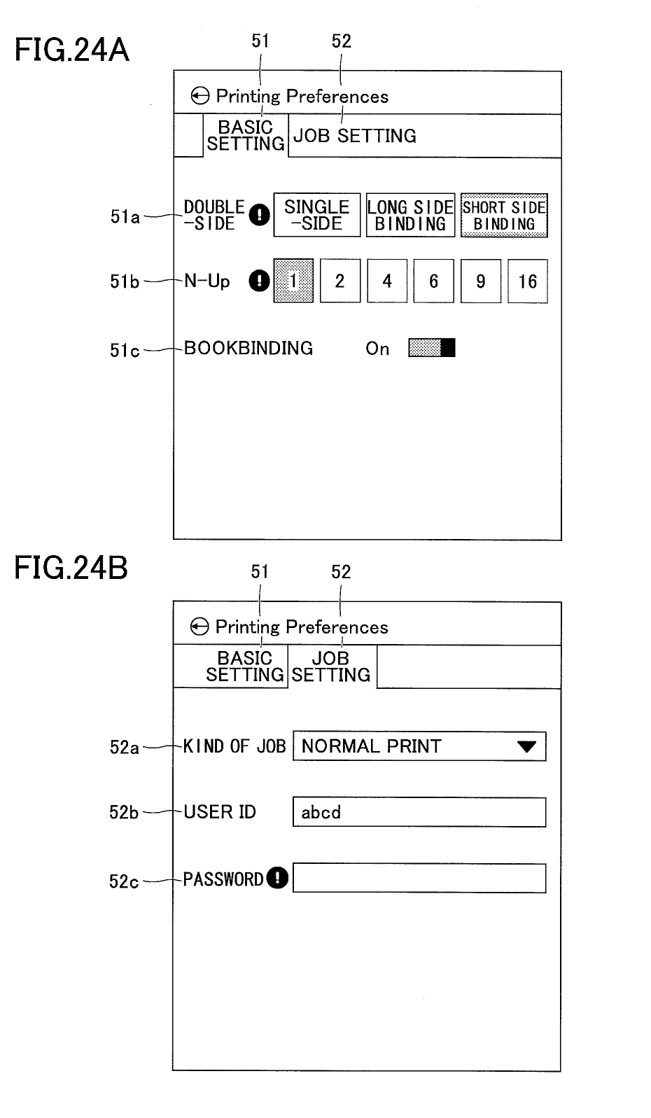

The GUI generation unit 32 updates the display of the GUI screen based on the extended print setting information changed as above and the GUI layout setting. FIGS. 24A and 24B illustrate first example of the display of the updated GUI screen.

In the basic setting tab shown in FIG. 24A, since “ColorMode” described in the GUI layout setting is not described in the extended print setting information, “ColorMode” becomes not displayed and a display space is removed. “Duplex (double-side)” 51a, “PagesPerSheet (N-up)” 51b, “Booklet (bookbinding)” 51c are displayed according to the UI kinds described in the GUI layout setting. “Duplex (double-side)” 51a and “PagePerSheet (N-up)” 51b are prohibited and prohibition reason display icons (!) are displayed.

In the job setting tab shown in FIG. 24B, “JobMode (kind of jobs)” 52a, “UserID (User ID)” 52b and “Password (password)” 52c are displayed. “Password” 52c is prohibited, and is displayed in gray down. The user's input is prohibited, and a prohibition reason display icon (!) is displayed.

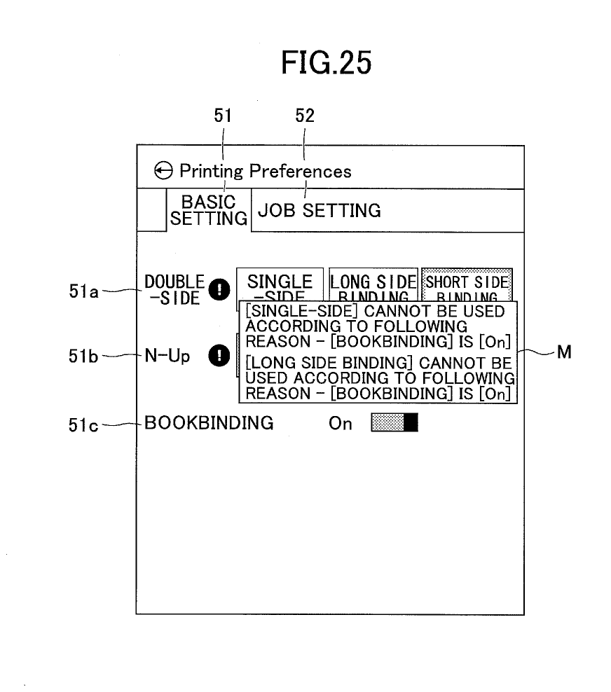

Also in the case where the options are prohibited, as shown in FIG. 25, a message M presenting the reason of prohibition is displayed. In this case, the message M presenting the reason of prohibition is displayed for each of the prohibited options.

(Second Other Example of Extended Print Setting Information)

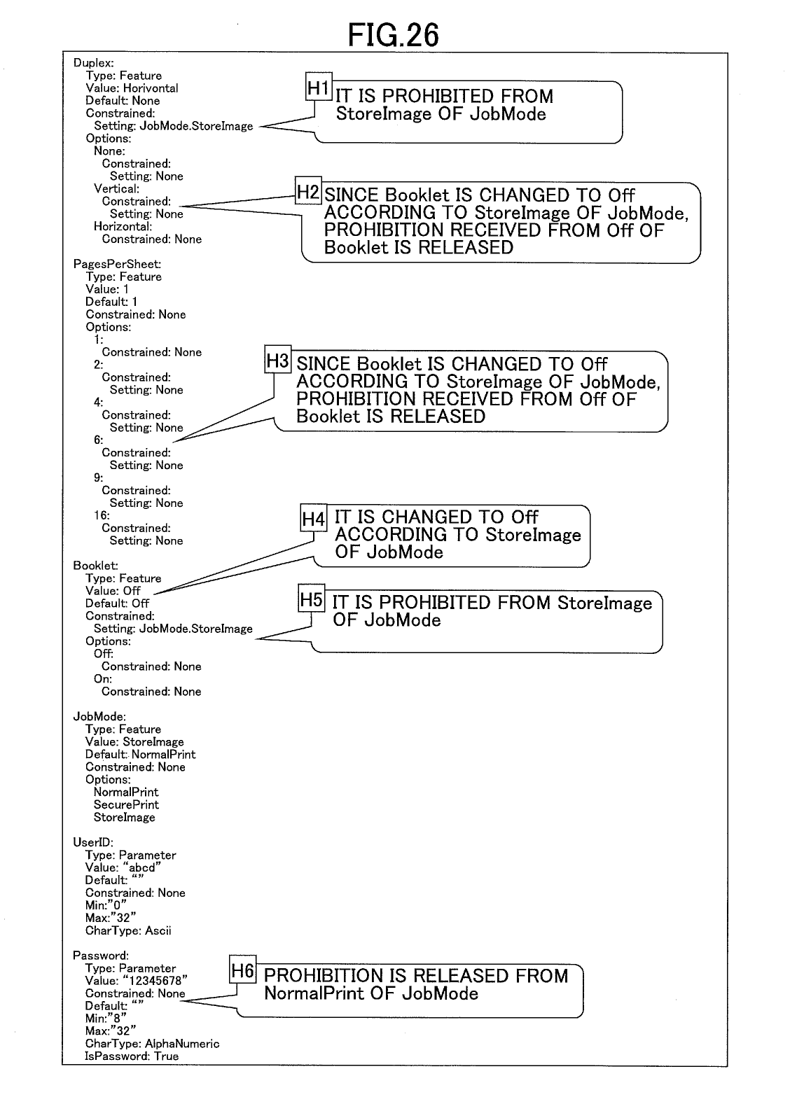

Next, the second other example of the extended print setting information will be explained with reference to FIG. 26. FIG. 26 illustrates an example of the extended print setting information in which “JobMode” is changed to “StoreImage” and a value of “12345678” is input to “Password”.

Since the value of “JobMode” is changed to “StoreImage”, in “H1” and “H5” in FIG. 26, “Duplex” and “Booklet” are prohibited and become unusable, and in “H4”, the setting value of “Booklet” is forcibly changed to “Off”. Moreover, in “H2” and “H3”, the prohibitions on the options in “Duplex” and “PagesPerSheet” are released. Moreover, in “H6”, the prohibition on “Password” is also released.

(Second Example of Display of GUI Screen)

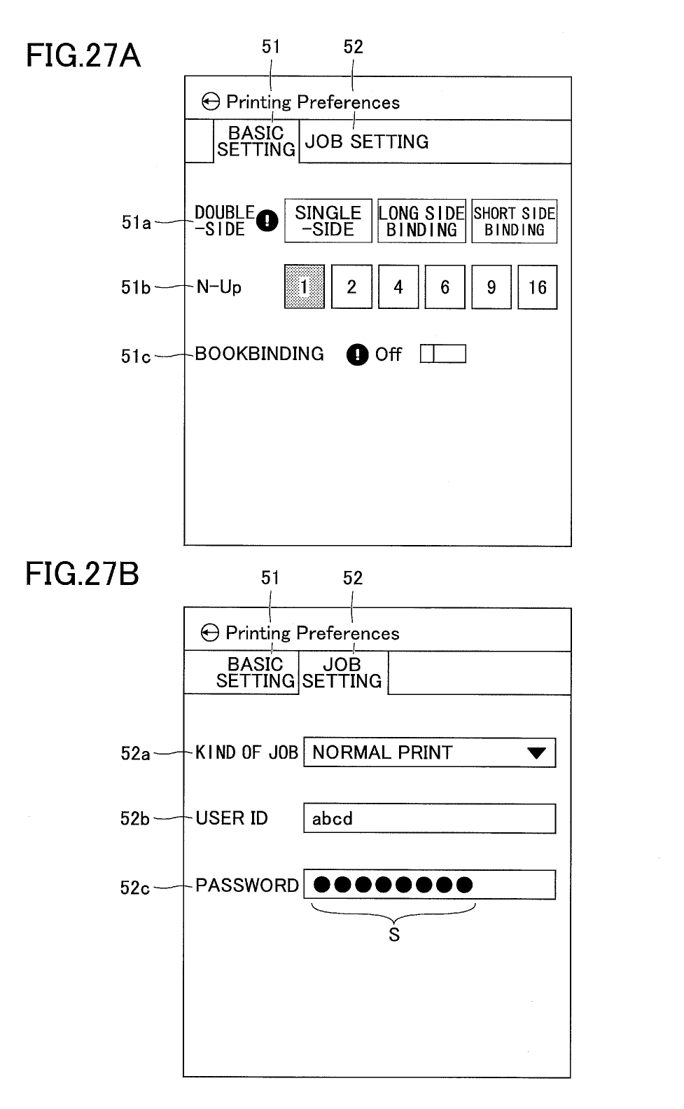

The GUI generation unit 32 updates the display of the GUI screen based on the extended print setting information changed as above and the GUI layout setting. FIGS. 27A and 27B illustrate a second example of the display of the updated GUI screen.

In the basic setting tab shown in FIG. 27A, “Duplex (double-side)” 51a, “PagesPerSheet (N-up)” 51b, “Booklet (bookbinding)” 51c are displayed based on the GUI layout setting. “Duplex (double-side)” 51a and “Booklet (bookbinding)” 51c are prohibited and prohibition reason display icons (!) are displayed.

In the job setting tab shown in FIG. 27B, “JobMode (kind of jobs)” 52a, “UserID (User ID)” 52b and “Password (password)” 52c are displayed. Since “IsPassword” in “Password (password)” in the extended print setting information in FIG. 26 is “True”, the GUI generation unit 32 masks the value input into “Password” with filled circles S, and displays so as not to be made out.

[Variation of Print System]

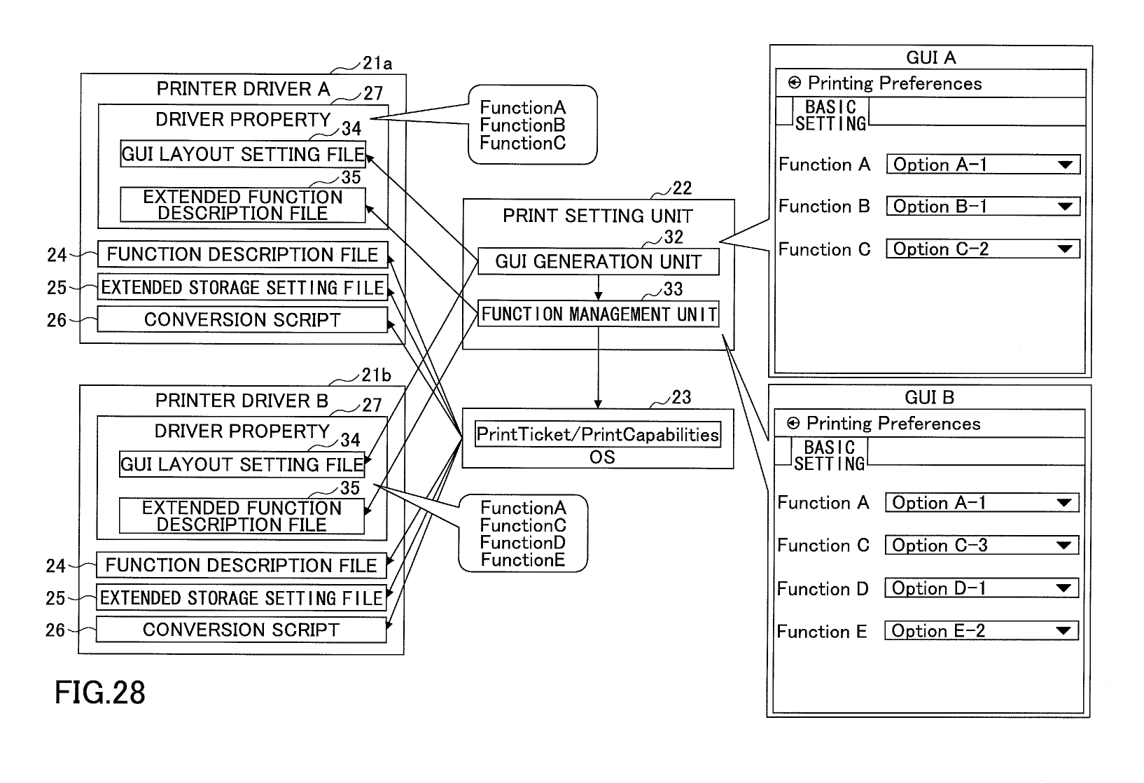

Next, a variation of a print system according to the present embodiment will be explained with reference to FIG. 28. FIG. 28 illustrates an example of the print system including one print setting unit 22 for a printer driver “A” 21a and a printer driver “B” 21b and displaying a GUI screen. The number of printer drivers is not limited to two. The print system may have a configuration including one print setting unit 22 for plural printer drivers.

The printer driver “A” 21a or the printer driver “B” 21b may be distributed as a package to every model in which a driver is installed. Moreover, the same models with a printer driver of an old version and with a printer driver of a new version may be mixed.

If a print setting application which realizes a different function of the print setting unit 22 dedicated to each model and each version is distributed, a development load becomes heavy and a user feels confused about a large number of kinds of applications. Accordingly, one print setting application preferably uses plural kinds of drivers.

In the configuration according to the present embodiment, as described above, and to the variation, a function of the GUI layout setting file 34 or the extended function description file 35, which depends on the printer driver, is included in a package of the printer driver 21 (a driver property 27). On the other hand, a function of the GUI generation unit 32 or the function management unit 33, which reads setting values from these files and performs a process, is included in the print setting unit 22 (print setting application). According to the above configuration, in the present embodiment and the variation, the plural printer drivers can be the print setting unit 22 can display a GUI screen “A” and a GUI screen “B” suitable for the driver.

Only for extending a function which cannot be realized only by the function description, it can be realized by providing the print setting application having the function of the print setting unit 22 with the function of the GUI layout setting file 34 or the extended function description file 35. However, by providing the printer driver with the function of the GUI layout setting file 34 or the extended function description file 35, the one print setting application can use the plural drivers.

As explained above, the print system 1 according to the present embodiment can set an extended function description, which is not included in the function description of the predetermined print setting item, as a print setting item.

Especially, even under the constraint of Windows (trademark registered) version 4 driver, the print system 1 according to the present embodiment operates correctly for print setting items of drivers of plural models or of different versions. Therefore, according to the present embodiment, by using a method which does not destroy the affinity of Windows, a detailed prohibition can be realized on the DCA 4, for the print setting items of drivers of plural models or of different versions.

Moreover, in the present embodiment, the setting of prohibitions for all the functions and the setting for the layout of the GUI screen are maintained in the driver property 27. The print setting unit 22, for example, acquires the information as described above by using an application provided by the OS of Windows or the like, reads the information by a prohibition resolution module or a GUI display module which is maintained on the side of the print setting unit 22, and operates. Accordingly, for example, to a user who performs a print job from a UI screen in Windows or the like, a detailed prohibition on a setting item or the layout of the GUI screen can be provided. Moreover, by one print setting unit 22, the effect as described above can be provided to the drivers of plural models or of different versions.

Moreover, the extended function description according to the present embodiment includes a description of a prohibition rule between print setting items. Accordingly, a prohibition condition which cannot be described by a standard function description can be executed.

Moreover, according to a value set by the user using the UI screen for print setting, the prohibition condition can be changed dynamically. Accordingly, by changing the prohibition condition dynamically, the user can perform the print setting more smoothly.

(Example of Hardware Configuration)

Finally, an example of the hardware configuration of the control unit 20 according to the present embodiment will be explained. FIG. 29 is a diagram illustrating an example of the hardware configuration of the control unit 20 according to the present embodiment.

As shown in FIG. 29, the control unit 20 includes an input device 101, a display device 102, an external I/F (interface) 103, a RAM (Random Access Memory) 104, a ROM (Read Only Memory) 105, a CPU (Central Processing Unit) 106, a communication I/F 107, a HDD (Hard Disk Drive) 108, or the like. The above devices and units are connected with each other via a bus B.

The input device 101 includes a keyboard or a mouse, and is used for inputting respective manipulation signals into the control unit 20. The display device 102 includes a display or the like and displays a result or the process by the control unit 20.

The communication I/F 107 is an interface that connects the control unit 20 to a network 9. Accordingly, the control unit 20 can perform data communications with another device, such as an “image processing apparatus”, an “information processing apparatus” or the like, such as the printer 8 or the like, via the communication I/F 107.

The HDD 108 is a non-volatile storage device that stores a program or data. The stored program or data includes an OS (Operating System) 23 which is a basic software controlling the entire apparatus, an application software that provides various functions on the OS 23 and the like. Moreover, the HDD 108 manages the stored program and data by a predetermined file system and/or a DB (Data Base).

The external I/F 103 is an interface with an external device. The external device includes a recording medium 103a or the like. Accordingly, the control unit 20 can read from and/or write into the recording medium 103a via the external I/F 103. The recording medium 103a includes a floppy disk (trademark or registered trademark), a CD (Compact Disk) and a DVD (Digital Versatile Disk), and a SD (Secure Digital) card or a USB (Universal Serial Bus) memory or the like.

The ROM 105 is a non-volatile semiconductor memory (storage device) that can maintain internal data even when the power is turned off. The ROM 105 stores a program or data including a BIOS (Basic Input/Output System) which is executed at the time of startup of the control unit 20, an OS setting, a network setting and the like. The RAM 104 is a volatile semiconductor memory (storage device) that temporarily holds a program or data. The CPU 106 is an arithmetic device that realizes a control of the entire apparatus or an installed function by reading out a program or data on the RAM from the above storage device (for example, the “HDD”, “ROM” or the like) and executing processes.

As described above, the control unit 20 according to the present embodiment can provide various kinds of information processing service including the print control according to the hardware configuration. For example, the control unit 20, by executing at the CPU 106 various control programs stored in the ROM 105, exercises the control of the entire PC 7, and by executing the print control program accessible in the printer driver 21 which is stored in the ROM 105, executes the print control of the printer 8 and various processes according to the present invention.

Respective parts of the printer driver 21 and the print setting unit 22 according to the present embodiment are realized by a process that a program installed in the HDD 108 makes the CPU 106 execute. Moreover, various kinds of data of the function description, the extended function description, the print capability, the print ticket and the extended print setting information can be stored in the RAM 104, the HDD 108 or a storage device connected via the network 9.

The embodiments of the information processing apparatus, the print control program and the print system according to the present invention are explained in detail with reference to the accompanying drawings. However, the present invention is not limited to these embodiments. Various variations and modifications may be made without departing from the scope of the present invention.

The present application is based on and claims the benefit of priority of Japanese Priority Applications No. 2013-066053 filed on Mar. 27, 2013 and No. 2014-032143 filed on Feb. 21, 2014 with the Japanese Patent Office, the entire contents of which are hereby incorporated by reference.

What is claimed is:

1. An information processing apparatus, comprising:
a first generation unit that generates process information, based on function description information indicating a plurality of setting items related to a function of an image processing apparatus and a prohibition at the plurality of setting items, and additional function information indicating information for requiring of the image processing apparatus a function different from a function of the plurality of setting items indicated by the function description information, the process information being related to a process required of the image processing apparatus;
a second generation unit that generates extended print setting information, based on extended function description information indicating a prohibition different from the prohibition indicated by the function description information, and the process information generated by the first generation unit, the extended print setting information being for performing a display reflecting the prohibition indicated by the extended function description information; and
a display control unit that displays a screen for receiving a setting related to a print process required of the image processing apparatus, based on the extended print setting information generated by the second generation unit.

2. The information processing apparatus as claimed in claim 1, further comprising a reception unit that receives the setting related to the print process based on the screen displayed by the display control unit, wherein the second generation unit further generates the extended print setting information reflecting a prohibition related to the received setting, based on a comparison between the setting received by the reception unit and the function extension description information.

3. The information processing apparatus as claimed in claim 2, wherein the second generation unit and the display control unit can operate independently of a printer driver of the information processing apparatus.

4. The information processing apparatus as claimed in claim 1, wherein the display control unit removes function description information, indicating a prohibition in a setting item, which a user cannot change, out of the plurality of setting items, from a setting item of an object in which function description information is changed, and makes the setting item removed from the object in which function description information is changed not to be displayed.

5. The information processing apparatus as claimed in claim 4, wherein the display control unit uses a display region of the setting item which is made not to be displayed for a display region of other setting item.

6. A non-transitory computer-readable storage medium storing a program for causing a computer to perform a process of controlling printing, the process comprising:
a first generation step of generating process information, based on function description information indicating a plurality of setting items related to a function of an image processing apparatus and a prohibition at the plurality of setting items, and additional function information indicating information for requiring of the image processing apparatus a function different from a function of the plurality of setting items indicated by the function description information, the process information being related to a process required of the image processing apparatus;
a second generation step of generating extended print setting information, based on extended function description information indicating a prohibition different from the prohibition indicated by the function description information, and the process information generated in the first generation step, the extended print setting information being for performing a display reflecting the prohibition indicated by the extended function description information; and
a display control step of displaying a screen for receiving a setting related to a print process required of the image processing apparatus, based on the extended print setting information generated in the second generation step.

7. The non-transitory computer-readable storage medium as claimed in claim 6, the process further comprising a reception step of receiving the setting related to the print process based on the screen displayed in the display control step, wherein in the second generation step, the extended print setting information reflecting a prohibition related to the received setting is further generated, based on a comparison between the setting received in the reception step and the function extension description information.

8. The non-transitory computer-readable storage medium as claimed in claim 6, wherein in the display control step, function description information, indicating a prohibition in a setting item, which a user cannot change, out of the plurality of setting items, is removed from a setting item of an object in which function description information is changed, and the setting item removed from the object in which function description information is changed is made not to be displayed.

9. The non-transitory computer-readable storage medium as claimed in claim 8, wherein in the display control step, a display region of the setting item which is made not to be displayed is used for a display region of other setting item.

10. A print system including an information processing apparatus and an image processing apparatus, which are connected to each other via a network, the image processing apparatus comprising:
a first generation unit that generates process information, based on function description information indicating a plurality of setting items related to a function of the image processing apparatus and a prohibition at the plurality of setting items, and additional function information indicating information for requiring of the image processing apparatus a function different from a function of the plurality of setting items indicated by the function description information, the process information being related to a process required of the image processing apparatus;
a second generation unit that generates extended print setting information, based on extended function description information indicating a prohibition different from the prohibition indicated by the function description information, and the process information generated by the first generation unit, the extended print setting information being for performing a display reflecting the prohibition indicated by the extended function description information; and
a display control unit that displays a screen for receiving a setting related to a print process required of the image processing apparatus, based on the extended print setting information generated by the second generation unit, wherein the image processing apparatus processes print target data based on the extended print setting information.
